(19) United States
(12) Patent Application Publication
(10) Pub. No.: US 2026/0330207 A1
(43) Pub. Date: Oct. 22, 2026

(54) HETEROGENEOUS COMPUTING MEMORY DEVICE AND ARTIFICIAL INTELLIGENCE COMPUTING SYSTEM INCLUDING THE SAME

(71) Applicant: Samsung Electronics Co., Ltd., Suwon-si (KR)

(72) Inventors: Yongsuk Kwon, Suwon-si (KR); Sangsu Park, Suwon-si (KR); Jung Ho Ahn, Seoul (KR); Juhwan Cho, Seoul (KR); Kwanhee Kyung, Seoul (KR); Jinin So, Suwon-si (KR); Sungmin Yun, Seoul (KR)

(73) Assignees: Samsung Electronics Co., Ltd., Suwon-si (KR); Seoul National University R&DB Foundation, Seoul (KR)

(21) Appl. No.: 19/446,433

(22) Filed: Jan. 12, 2026

(30) Foreign Application Priority Data
Apr. 18, 2025 (KR) 10-2025-0050877

(51) Int. Cl. G06N 3/063; G06F 13/40; G06N 3/045

(52) U.S. Cl. CPC G06N 3/063; G06F 13/4031; G06N 3/045; G06F 2213/0026

(57) ABSTRACT

A heterogeneous computation memory device includes a memory including a processing-in-memory (PIM), a processing-near-memory (PNM) unit, and a controller configured to receive first to third requests from a processing device via a host channel, and to control the memory and the PNM unit via the memory channel. The first request corresponds to a first layer having a first computational intensity, the second request corresponds to a second layer having a second computational intensity, and the third request corresponds to a third layer having a third computational intensity. The controller transmits first target data stored in the memory to the external computation unit in response to the first request, controls the PNM unit to process the second layer in response to the second request, and controls the memory to process the third layer in response to the third request.

### CROSS-REFERENCE TO RELATED APPLICATION(S)

This U.S. non-provisional patent application claims priority under 35 USC § 119 to Korean Patent Application No. 10-2025-0050877, filed on Apr. 18, 2025, the entirety of which is hereby incorporated by reference.

### TECHNICAL FIELD

The present disclosure relates to an artificial intelligence device, and more particularly, to a heterogeneous computing memory device and an artificial intelligence operation system including the same.

### BACKGROUND

Artificial intelligence (AI) is a field of computer science that artificially implements various abilities, such as learning, reasoning, and perception, similar to those of humans. Recently, artificial intelligence has been widely utilized in various fields, including natural language understanding, translation, robotics, artificial vision, problem-solving, learning, knowledge acquisition, and cognitive science.

As an example, a Large Language Model (LLM) configured to perform Natural Language Processing (NLP) is in the spotlight. In the LLM, a high-speed computation for a large amount of data is required, and various computation devices or memory devices have been developed for this purpose.

### SUMMARY

The present disclosure provides a heterogeneous computing memory device having improved performance and improved operation efficiency, and an artificial intelligence operation system including the same.

According to some implementations of the present disclosure, a heterogeneous computing memory device includes: a memory including a processing-in-memory (PIM) unit; a processing-near-memory (PNM) unit; and a controller configured to receive first to third requests from an external processing device via a host channel and, in response to the first to third requests, control the memory and the PNM unit via a memory channel. The first request corresponds to a first layer having a first computational intensity, the second request corresponds to a second layer having a second computational intensity lower than the first computational intensity, and the third request corresponds to a third layer having a third computational intensity lower than the second computational intensity, and the controller is further configured to: in response to the first request, provide first target data stored in the memory to the external processing device, in response to the second request, control the PNM unit to process the second layer by the PNM unit; and in response to the third request, control the memory to process the third layer by the PIM unit of the memory.

According to some implementations of the present disclosure, an artificial intelligence computing system configured to infer an artificial intelligence model is provided. The system includes a first heterogeneous computing memory device; and a first processing device coupled to the first heterogeneous computing memory device via a first host channel, and configured to infer the artificial intelligence model. The first heterogeneous computing memory device includes a first processing-near-memory (PNM) unit; a first memory including a first processing-in-memory (PIM) unit, and configured to store data; and a first controller connected to the first memory and the first PNM unit via a first memory channel, and configured to control the first memory and first PNM unit in response to a request from the first processing device. The artificial intelligence model comprises a plurality of layers, and the plurality of layers are processed by the first processing device, the first PNM unit, or the first PIM unit included in the first memory according to computing intensities of the plurality of layers.

According to some implementations of the present disclosure, an artificial intelligence computing system comprises a processing device configured to process a first layer of a first computational intensity; and a heterogeneous computing memory device configured to process a second layer having a second computational intensity lower than the first computational intensity and a third layer having a third computational intensity less than the second computational intensity. The heterogeneous computing memory device includes a processing-near-memory (PNM) unit configured to process the second layer; and a memory configured to store data, the memory including a processing-in-memory (PIM) unit configured to process the third layer.

### BRIEF DESCRIPTION OF THE DRAWINGS

The foregoing and other features of the present disclosure will be described below in more detail with reference to the accompanying drawings of non-limiting implementations of the present disclosure in which like reference characters refer to like parts throughout the different views. The drawings are not necessarily to scale. Emphasis is instead being placed upon illustrating principles of the present disclosure.

FIG. 1 is a block diagram illustrating an artificial intelligence computing system according to some implementations of the present disclosure.

FIG. 2 is a block diagram illustrating the heterogeneous computation memory device of FIG. 1.

FIG. 3 is a block diagram illustrating the first DRAM of FIG. 2.

FIG. 4 is a flowchart illustrating an example operation of the artificial intelligence computing system of FIG. 1.

FIG. 5A and FIG. 5B are diagrams for describing an example operation of the artificial intelligence computing system of FIG. 1.

FIG. 6A and FIG. 6B are diagrams for describing an example operation of the artificial intelligence computing system of FIG. 1.

FIG. 7A and FIG. 7B are diagrams for describing an example operation of the artificial intelligence computing system of FIG. 1.

FIG. 8A and FIG. 8B are diagrams for describing an example operation of the artificial intelligence computing system of FIG. 1.

FIGS. 9A, 9B, 10A, 10B, 11A, 11B, 12A, and 12B are diagrams for describing inference of different example large language models using the artificial intelligence computing system of FIG. 1.

FIGS. 13 to 19 are block diagrams illustrating an example artificial intelligence computing system according to some implementations of the present disclosure.

FIG. 20 is a diagram illustrating an example data center to which a heterogeneous computing memory device according to some implementations of the present disclosure is applied.

### DETAILED DESCRIPTION

In the following, implementations of the present disclosure will be described clearly and in detail to the extent that a person skilled in the art can easily practice the present disclosure.

Terms such as “block,” “unit or portion,” “module,” or the like, or configurations corresponding thereto, or functional blocks or circuits in the drawings, as used below, may be implemented in the form of software, hardware, or a combination thereof configured to perform or process various functions, operations, or features described in the detailed description.

In the following, where various components are listed via the conjunction of “or,” this may refer to each of the listed components, or to a combination of at least some. For example, “A, B, or C” can mean each of A, B, and C, or can mean a combination of A and B, a combination of B and C, a combination of A and C, and a combination of A, B, and C.

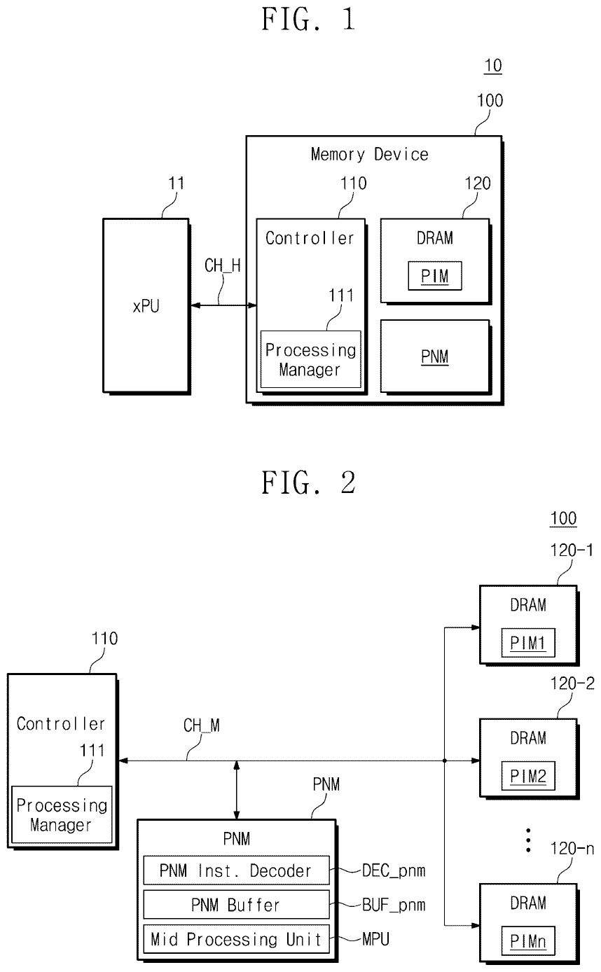

FIG. 1 is a block diagram illustrating an artificial intelligence computing system according to some implementations of the present disclosure. In some implementations, the artificial intelligence computing system 10 may be configured to perform artificial intelligence computation, inference, or learning. In some implementations, an artificial intelligence model or weights may be generated via machine learning. The machine learning may include various learning methods such as supervised learning, unsupervised learning, semi-supervised learning, reinforcement learning, and the like, but the scope of the present disclosure is not limited thereto.

In some implementations, the artificial intelligence model may be generated or learned through one or a combination of at least two or more of various neural networks, such as a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, and the like.

In some implementations, the artificial intelligence model may be a Large Language Model (LLM) configured to perform various Natural Language Processing (NLP), and may be learned or generated using a Transformer model. The artificial intelligence model may include a plurality of neural network layers. Each of the plurality of neural network layers may be configured to perform an artificial intelligence computation based on the learned model or weights.

In some implementations, the artificial intelligence computing system 10 may be an accelerator configured to perform various artificial intelligence computations, inferences, or learnings described above. Alternatively, the artificial intelligence computing system 10 may include at least one of various information processing devices such as a personal computer, a laptop computer, a server, a workstation, a smartphone, a tablet PC, and the like. Alternatively, the artificial intelligence computing system 10 may be a data center configured to store and manage various data, or may be included in a storage server or an application server included in the data center. Alternatively, the artificial intelligence computing system 10 may be an electronic system for a vehicle, such as a navigation, autonomous driving system. However, the scope of the present disclosure is not limited thereto.

Referring to FIG. 1, an artificial intelligence computing system 10 may include a processing device 11 and a heterogeneous computing memory device 100. The processing device 11 may perform various artificial intelligence computations or operations. The processing device 11 may be arithmetic hardware optimized for large-scale neural network processing such as various types of processing units (xPUs), for example, a Sensor Processing Unit (TPU) or a Neural Processing Unit (NPU), or arithmetic hardware optimized for parallel arithmetic processing such as a Graphics Processing Unit (GPU). However, the scope of the present disclosure is not limited thereto, and the processing device 11 may be a central processing unit (CPU) configured to process various operations or may include various other suitable computing hardware.

The heterogeneous computing memory device 100 may operate under the control of the processing device 11. For example, the heterogeneous computing memory device 100 may communicate with the processing device 11 through the host channel CH_H. The host channel CH_H may be compatible with a predetermined interface between the processing device 11 and the heterogeneous computing memory device 100. In some implementations, the predetermined interface may be a Compute eXpress Link (CXL) interface. However, the scope of the present disclosure is not limited thereto, and the predetermined interface may include at least one of various interfaces such as an Advanced Technology Attachment (ATA), a Serial ATA (SATA), an External SATA (e-SATA), a Small Computer System Interface (SCSI), a Serial Attached SCSI (SAS), a Peripheral Component Interconnection (PCI), a PCI express (PCIe), an NVM express (NVMe), an IEEE 1394, a universal serial bus (USB), a secure digital (SD) card, a multi-media card (MMC), an embedded multi-media card (eMMC), a Universal Flash Storage (UFS), an embedded Universal Flash Storage (eUFS), and/or a compact flash (CF) card interface.

The heterogeneous computing memory device 100 may include a controller 110, a dynamic random access memory (DRAM) 120, and a Processing-Near-Memory unit PNM. The controller 110 may control the DRAM 120 or the Processing-Near-Memory unit PNM according to the control of the processing device 11.

The DRAM 120 may operate under the control of the controller 110. For example, the DRAM 120 may be configured to store data or output stored data under the control of the controller 110. For ease of description, it is described as the heterogeneous computing memory device 100, which includes the DRAM 120, but the scope of the present disclosure is not limited thereto. The heterogeneous computing memory device 100 may include at least one of various memories such as DRAM, MRAM, ReRAM, TRAM, SRAM, flash memory, and the like. Alternatively, the DRAM 120 of the heterogeneous computing memory device 100 may be replaced with at least one of the various memories described above.

The DRAM 120 may include a Processing-In-Memory (PIM) (hereinafter, for ease of description, referred to as an “internal processing unit”). The internal processing unit PIM may be configured to process various computations within the DRAM 120. For example, the internal processing unit PIM may be configured to read data stored in memory cells of the DRAM 120 and perform various computations on the read data. The computation result of the internal processing unit PIM may be stored in memory cells of the DRAM 120 or provided to the controller 110. In some implementations, the internal processing unit PIM may perform an operation on a memory cell-by-memory cell basis by controlling the amount of charge stored in each capacitor of the memory cell. Alternatively, the internal processing unit PIM may use an arithmetic logic circuit to perform computation on the digital signal read from the memory cells. However, the scope of the present disclosure is not limited thereto, and the internal processing unit PIM may be implemented in various ways.

The Processing-Near-Memory unit PNM (hereinafter referred to as “near processing unit” for ease of description) may be configured to perform various computations on data read from the DRAM 120. For example, the near processing unit PNM may read data from the DRAM 120 under the control of the controller 110. The near processing unit PNM may perform various computations on the read data under the control of the controller 110. The results of the computations may be stored in the DRAM 120 or provided to the controller 110.

As described above, each of the processing device 11, the near processing unit PNM, and the internal processing unit PIM may be configured to perform various computations. In this case, the operation characteristics of each of the processing device 11, the near processing unit PNM, and the internal processing unit PIM may be different from each other.

For example, an internal processing unit PIM is located within the DRAM 120 and may perform computations on data read directly from memory cells of the DRAM 120. Therefore, since data does not have to be transmitted to the outside of the DRAM 120, there is no limitation on the data bandwidth. However, since the internal processing unit PIM is located inside the DRAM 120, the available area is limited, and thus the computational complexity that can be handled by the internal compute unit of PIM may be relatively low.

The processing device 11 is located outside the heterogeneous computing memory device 100, and may perform a computation on data received from the heterogeneous computing memory device 100. Thus, there is a limitation on the data bandwidth between the controller 110 and the DRAM 120, as well as a limitation on the data bandwidth between the controller 110 and the processing device 11. On the other hand, since the processing device 11 is separately provided outside the heterogeneous computing memory device 100, area constraints are reduced, allowing the processing device 11 to handle relatively higher computational complexity.

The near processing unit PNM is located outside the DRAM 120, and may perform a computation on data received from the DRAM 120. Thus, there is a limitation of the data bandwidth between the DRAM 120 and the near processing unit PNM. Since the near processing unit PNM is provided outside the DRAM 120, the area limitation is less than that of the internal processing unit PIM. However, since the near processing unit PNM is provided inside the heterogeneous computation memory device 100, the limitation for the area is greater than that of the processing device 11. Accordingly, the computational complexity that can be handled by the near processing unit PNM may be higher than that of the internal processing unit PIM and may be lower than that of the processing device 11.

As described above, each of the processing device 11, the near processing unit PNM, and the internal processing unit PIM has different computation characteristics. In other words, the computational intensity optimized by each of the processing device 11, the near processing unit PNM, and the internal processing unit PIM may be different from each other.

For example, a computational intensity may refer to the required number of computational operations per unit of data (or one access). For example, a relatively high computational intensity may mean a relatively greater number of computational operations per unit of data or a high computational complexity. In other words, this may mean that the number of operations performed per one memory access is relatively large or the operation complexity is high. On the other hand, the relatively low computation intensity may mean that the number of computational operations per unit data is relatively small or the computational complexity is low. As an example, the computational intensity may be expressed in units of “Operation per Byte (Op/B)”.

According to some implementations of the present disclosure, since the processing device 11 has a relatively high computational complexity, it is possible to process layers having a relatively high computational intensity. Since the internal processing unit PIM has a relatively low operation complexity, it is possible to process layers with a relatively low computational intensity. Since the near processing unit PNM has medium computational complexity, it is possible to process layers of medium computational intensity.

In some implementations, the operation efficiency for the artificial intelligence model may be improved by distributing operations on a plurality of layers of the artificial intelligence model to the processing device 11, the internal processing unit PIM, and the near processing unit PNM. For example, the Large Language Model (LLM), which is a type of artificial intelligence model, may include various computational layers. The various computational layers may have various computational intensities, depending on the implementation. In this case, when a layer having a relatively high computational intensity is processed through the processing device 11, a layer having a relatively low computational intensity is processed via the internal processing unit PIM, and a layer having a medium computational intensity is processed by the near processing unit PNM, computational efficiency for the artificial intelligence model may be improved.

In some implementations, the processing device 11 may determine which component processes the current layer based on the computational intensity of the current layer. If the computational intensity of the current layer is relatively low, the processing device 11 may select the internal processing unit PIM as a component to process the current layer. If the computational intensity of the current layer is relatively high, the processing device 11 may select the processing device 11 as a component to process the current layer. If the computational intensity of the current layer is medium, the processing device 11 may select the near processing unit PNM as a component to process the current layer. The processing device 11 may generate a request based on the selection result. For example, the request may include information about the component to process the current layer. The generated request may be sent to the heterogeneous computation memory device 100.

The controller 110 of the heterogeneous computing memory device 100 may receive the request from the processing device 11 and perform an operation corresponding to the received request. For example, the controller 110 may include a processing manager 111. The processing manager 111 may determine, based on a request or a command received from the processing device 11, a component (hereinafter, for convenience of description, referred to as a target unit) on which an operation corresponding to the received request command is performed. As an example, the request from the processing device 11 may include information about a target unit. The processing manager 111 may determine the target unit based on the information included in the request.

In some implementations, when the internal processing unit PIM is selected as the target unit, the processing manager 111 may control the DRAM 120 and the internal processing unit PIM such that the internal processing unit PIM performs a computational operation corresponding to the current layer. When the near processing unit PNM is selected as the target unit, the processing manager 111 may control the DRAM 120 and the near processing unit PNM such that data of the DRAM 120 is transferred to the near processing unit and the near processing unit PNM performs a computational operation corresponding to the current layer. When the processing device 11 is selected as the target unit, the processing manager 111 may control the DRAM 120 such that data of the DRAM 120 is provided to the processing device 11.

FIG. 2 is a block diagram illustrating the heterogeneous computing memory device of FIG. 1. Referring to FIGS. 1 and 2, the heterogeneous computing memory device 100 may include a controller 110, a plurality of DRAMs 120-1 to 120-n, and a near processing unit PNM.

The controller 110 may control the plurality of DRAMs 120-1 to 120-n and the near processing unit PNM under the control of the processing device 11. For example, the controller 110, the plurality of DRAMs 120-1 to 120-n, and the near processing unit PNM may communicate with each other through the memory channel CH_M. The controller 110 may transmit a command to the plurality of DRAMs 120-1 to 120-n through the memory channel CH_M. The plurality of DRAMs 120-1 to 120-n may perform a corresponding operation (e.g., a read operation, a write operation, or a computational operation via an internal processing unit PIM) in response to the received command.

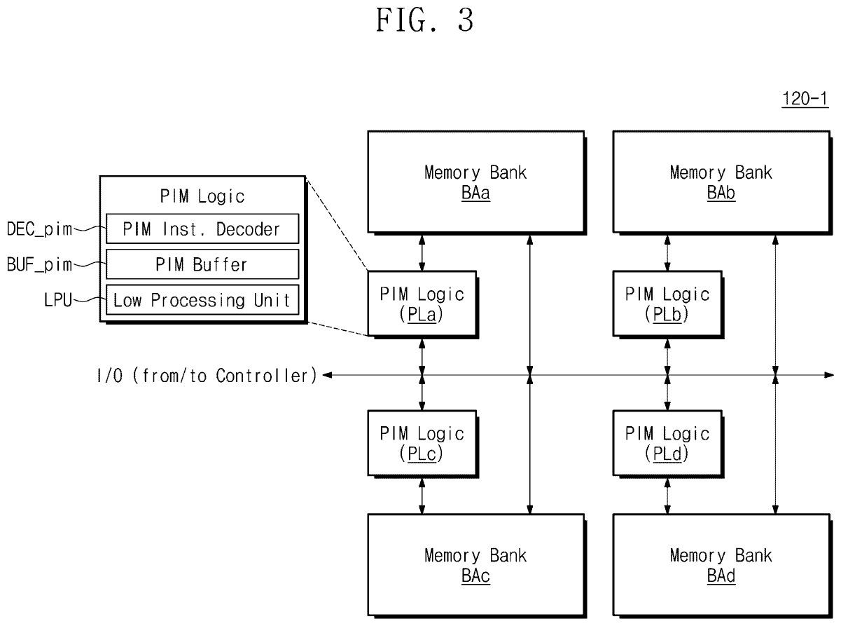

The plurality of DRAMs 120-1 to 120-n may include a plurality of internal processing units PIM1 to PIMn, respectively. For example, the first DRAM 120-1 may include a first internal processing unit PIM1, the second DRAM 120-2 may include a second internal processing unit PIM2, and the n-th DRAM 120-n may include an n-th internal processing unit PIMn. Each of the plurality of internal processing units PIM1 to PIMn may independently operate under the control of the controller 110. The configuration of the DRAM including the internal processing unit PIM is described in more detail with reference to FIG. 3.

The controller 110 may transmit a command to the near computing unit PNM through the memory channel CH_M. The near processing unit PNM may perform a corresponding operation in response to the received command. For example, the near processing unit PNM may include a processing-near-memory instruction decoder DEC_pnm, a processing-near-memory buffer BUF_pnm, and a medium processing unit MPU. The processing-near-memory instruction decoder DEC_pnm may decode a command received through the memory channel CH_M. The processing-near-memory buffer BUF_pnm may be configured to store data received from the plurality of DRAMs 120-1 to 120-n. The medium processing unit MPU may perform various computational operations on data stored in the processing-near-memory buffer BUF_pnm based on a decoding result of the processing-near-memory instruction decoder DEC_pnm. In some implementations, the medium processing unit MPU may include a matrix-multiplication unit (MMU).

In some implementations, the memory channel CH_M may be based on a high-speed interface such as a Double Data Rate (DDR), but the scope of the present disclosure is not limited thereto, and the memory channel CH_M may be based on various high-speed interfaces.

As described above, the near processing unit PNM is provided outside the plurality of DRAMs 120-1 to 120-n, and may share the same memory channel CH_M as the plurality of DRAMs 120-1 to 120-n. The configuration of the near processing unit PNM illustrated in FIG. 2 is some examples, and the scope of the present disclosure is not limited thereto. For example, the near processing unit PNM may further include various components (for example, an arithmetic logic unit ALU, an activation unit, or the like), depending on the implementation.

FIG. 3 is a block diagram illustrating the first DRAM of FIG. 2. For ease of description, a first DRAM 120-1 is shown in FIG. 3, but the scope of the present disclosure is not limited thereto, and other DRAMs 120-2 to 120-n may also have a structure similar to that of the first DRAM 120-1.

Referring to FIGS. 2 and 3, the first DRAM 120-1 may include a plurality of banks BAa to BAd and a plurality of internal memory processing logics PLa to PLd (hereinafter, for ease of description, referred to as an “internal processing logic”). In some implementations, the first internal processing unit PIM1 included in the first DRAM 120-1 of FIG. 2 may include a plurality of internal processing logics PLa to PLd of FIG. 3.

Each of the plurality of banks BAa to BAd may include a plurality of memory cells, an address decoder, a sense amplifier, and the like. As an example, each of the plurality of banks BAa to BAd may store data in a plurality of memory cells or output data stored in the plurality of memory cells through an input/output (I/O) line under the control of the controller 110.

The plurality of internal processing logics PLa to PLd may be connected to the plurality of banks BAa to BAd, respectively. The plurality of internal processing logics PLa to PLd may perform various computations or operations on data output from the plurality of banks BAa to BAd, respectively.

For example, the a-th internal processing logic PLa may receive data from the a-th bank BAa and perform a computation or an operation on the received data. The a-th internal processing logic PLa may include a processing-in-memory instruction decoder DEC_pim, a processing-in-memory buffer BUF_pim, and a low processing unit LPU. The processing-in-memory instruction decoder DEC_pim may be configured to decode the processing-in-memory instruction provided from the controller 110. The processing-in-memory buffer BUF_pim may be configured to store data received from the a-th bank BAa. The low processing unit LPU may perform a computation or an operation on data stored in the processing-in-memory buffer BUF_pim based on a decoding result of the processing-in-memory instruction decoder DEC_pim. In some implementations, the low processing unit LPU may include a vector-multiplication unit (VMU).

In some implementations, a computation result of the a-th internal processing logic PLa may be stored in the a-th bank BAa or provided to the controller 110 through an I/O line. In some implementations, according to an implementation or an operation type, the computation result of the a-th internal processing logic PLa may be stored in at least one of the banks BAb, BAc, and BAd other than the a-th bank BAa.

As described above, the first internal processing unit PIM1 is provided inside the first DRAM 120-1, and the computation on data read from the plurality of banks BAa to BAd may be performed inside the DRAM. The configurations of the first DRAM 120 and the first internal processing unit PIM1 shown in FIG. 3 are some examples, and the scope of the present disclosure is not limited thereto. For example, various components (for example, an arithmetic logic unit (ALU), an activation unit, and the like) may be further included according to an implementation of the first internal memory operation PIM1. Alternatively, according to an implementation, the first internal processing unit PIM1 may be included in each of the plurality of banks BAa to BAd.

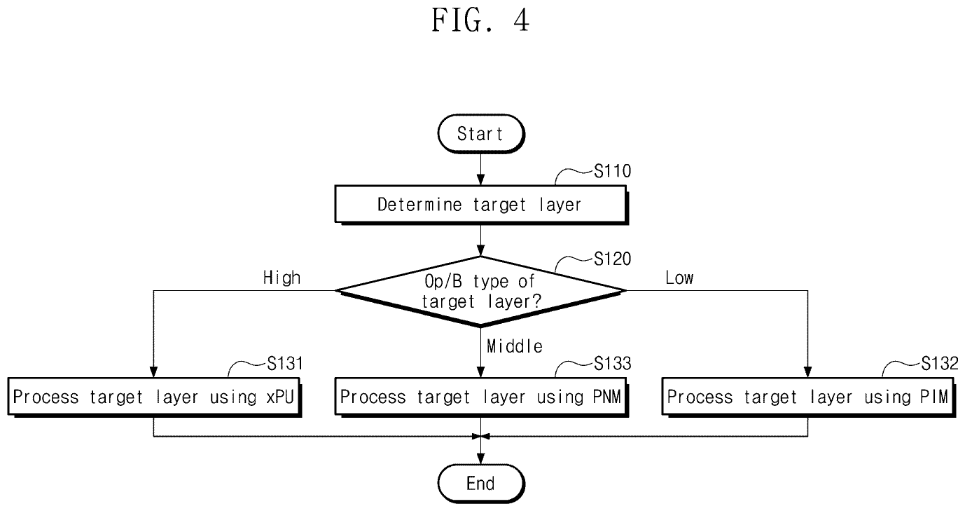

FIG. 4 is a flowchart illustrating the operation of the artificial intelligence computing system of FIG. 1. Referring to FIGS. 1 and 4, in a step S110, the artificial intelligence computing system 10 may determine a target layer. For example, the artificial intelligence computing system 10 may be configured to implement or execute an artificial intelligence model such as a large language model (LLM). The large language model LLM may be implemented sequentially or in parallel to perform computations or operations on a plurality of layers. The processing device 11 of the artificial intelligence computing system 10 may control an overall computing flow of the large language model LLM. The processing device 11 may determine a target layer to be currently performed from among the plurality of layers.

In a step S120, the artificial intelligence computing system 10 may determine the computational intensity of the target layer. In some implementations, each of the plurality of layers may have a different computational intensity. For example, operations on a first layer may have a relatively high computational intensity, operations on a second layer may have a medium computational intensity, and operations on a third layer may have a relatively low computational intensity. The processing device 11 may determine the computational intensity of the target layer that is currently being processed. In the following, for the sake of brevity of the drawings and ease of description, the computational intensity is denoted by the term “Op/B (Operation per Byte)”.

When the computational intensity of the target layer is relatively high, in a step S131, the artificial intelligence computing system 10 may process the target layer by using the processing device 11. For example, the processing device 11 may send a request for reading target data required to process the target layer to the heterogeneous computing memory device 100. In response to the request, the controller 110 of the heterogeneous computation memory device 100 may read target data from the DRAM 120 and transfer the target data to the processing device 11. The processing device 11 may perform a computation or an operation on the target data to process the target layer.

When the computational intensity of the target layer is relatively low, in step S132, the artificial intelligence computing system 10 may process the target layer using the internal processing unit PIM. For example, the processing device 11 may transmit a request including information on the internal processing unit PIM to the heterogeneous computing memory device 100. In response to the request, the controller 110 (or the processing manager 111) of the heterogeneous computing memory device 100 may transmit a processing-in-memory command to the DRAM 120. An internal processing unit PIM of the DRAM 120 may perform a computation or an operation on data read from a plurality of banks of the DRAM 120 to process a target layer in response to the processing-in-memory command. In some implementations, the computation result or the operation result may be stored in the DRAM 120 or provided to the processing device 11.

When the computational intensity of the target layer is medium, in step S133, the artificial intelligence computing system 10 may process the target layer by using the near processing unit PNM. For example, the processing device 11 may transmit a request including information on the near processing unit PNM to the heterogeneous computing memory device 100. In response to the request, the controller 110 (or the processing manager 111) of the heterogeneous computing memory device 100 may transmit an access command to the DRAM 120 and transmit a processing-near-memory command to the near processing unit PNM. The DRAM 120 may output the target data in response to the access command. The near processing unit PNM may process the target layer by performing an operation on the target data in response to the processing-near-memory command. In some implementations, the computation result or the operation result may be stored in the DRAM 120 or provided to the processing device 11.

As described above, according to some implementations of the present disclosure, the target layer may be processed through the processing device 11, the near processing unit PNM, or the internal processing unit PIM according to the computational intensity of the target layer. Since the target layer is processed through the optimal operation unit according to the computational intensity of the target layer, the operation efficiency can be improved.

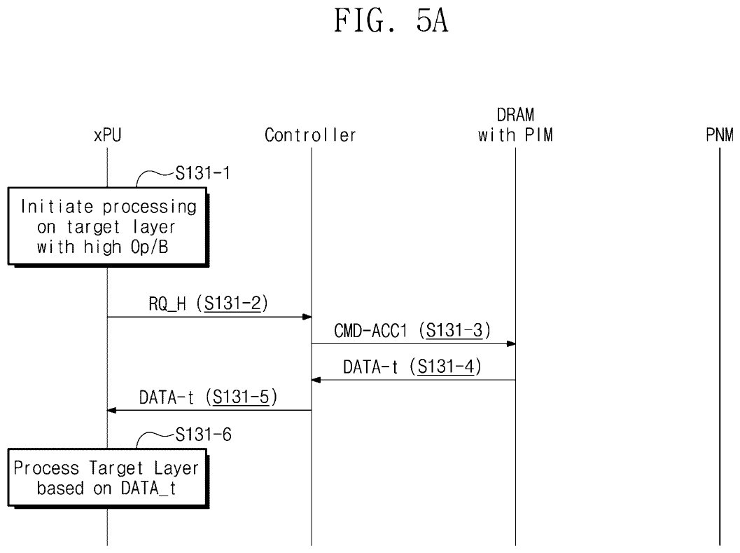

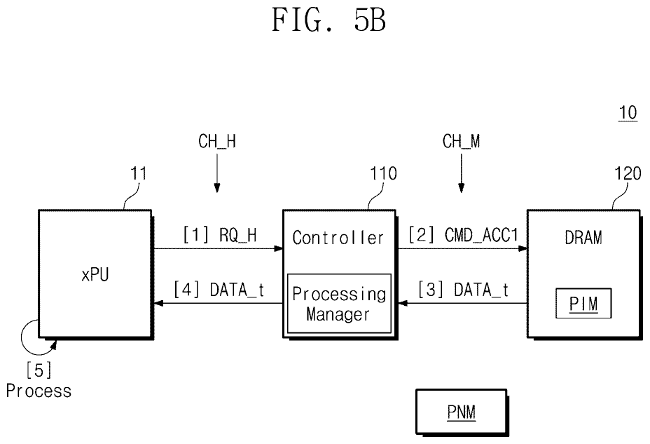

FIG. 5A and FIG. 5B are diagrams for describing the operation of the artificial intelligence computing system of FIG. 1. In some implementations, with reference to FIG. 5A and FIG. 5B, an operation (for example, the step S131 in FIG. 4) of processing a target layer with high computational intensity is described.

Referring to FIG. 5A and FIG. 5B, in a step S131-1, the processing device 11 may initiate processing on the target layer. In some implementations, the target layer may have a relatively high computational intensity (high Op/B).

In a step S131-2, the processing device 11 may transmit the first request RQ_H to the heterogeneous computing memory device 100. For example, as described above, a target layer having a high computational intensity will be processed by the processing device 11. In this case, the processing device 11 may need the target data DATA_t stored in the heterogeneous computing memory device 100 to process the target layer. The processing device 11 may transmit the first request RQ_H for reading out or accessing the target data DATA_t to the heterogeneous computing memory device 100. For example, as in operation [1] of FIG. 5B, the first request RQ_H may be transmitted to the heterogeneous computing memory device 100 through the host channel CH_H.

In a step S131-3, the controller 110 of the heterogeneous computing memory device 100 may transmit the first access command CMD_ACC1 to the DRAM 120 in response to the first request RQ_H. For example, the first request RQ_H may be a request for reading the target data DATA_t stored in the DRAM 120. Accordingly, in response to the first request RQ_H, the controller 110 may transmit the first access command CMD_ACC1 for reading the target data DATA_t stored in the DRAM 120 to the DRAM 120. In some implementations, as in operation [2] of FIG. 5B, the first access command CMD_ACC1 may be transmitted to the DRAM 120 through the memory channel CH_M.

In a step S131-4, the DRAM 120 may output the target data DATA_t in response to the first access command CMD_ACC1. For example, the DRAM 120 may perform a read operation on the target data DATA_t in response to the first access command CMD_ACC1. The DRAM 120 may provide the read target data DATA_t to the controller 110. In some implementations, as in operation [3] of FIG. 5B, the target data DATA_t may be transmitted to the controller 110 through the memory channel CH_M.

In a step S131-5, the controller 110 may transmit the target data DATA_t to the processing device 11. In some implementations, as in operation [4] of FIG. 5B, the target data DATA_t may be transmitted to the processing device 11 through the host channel CH_H.

In a step S131-6, the processing device 11 may process the target layer based on the target data DATA_t. For example, as in operation [5] of FIG. 5B, the processing device 11 may perform an operation on the target data DATA_t to process the target layer.

As described with reference to FIG. 5A and FIG. 5B, when the computational intensity of the target layer is relatively high, the target layer may be processed by the processing device 11. In this case, since the target data stored in the DRAM 120 passes through the memory channel CH_M and the host channel CH_H, the data bandwidth may be limited by the memory channel CH_M and the host channel CH_H. On the other hand, because the target layer is processed by the processing device 11 having a larger computational complexity, the computation efficiency may be improved.

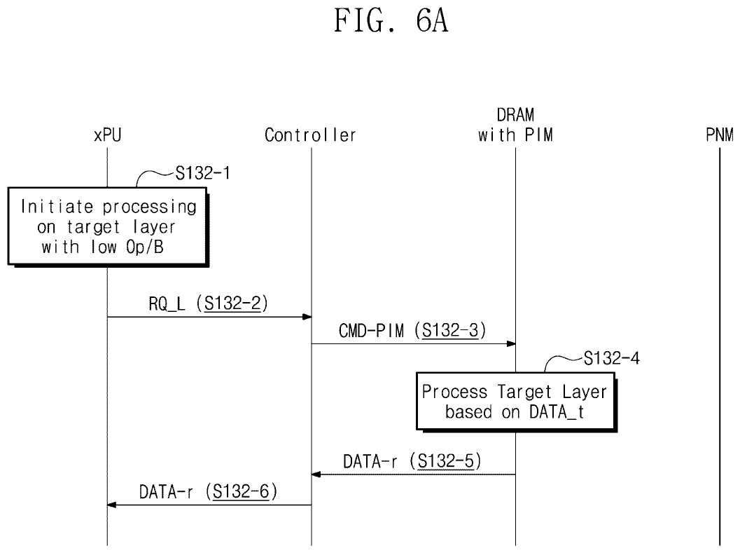

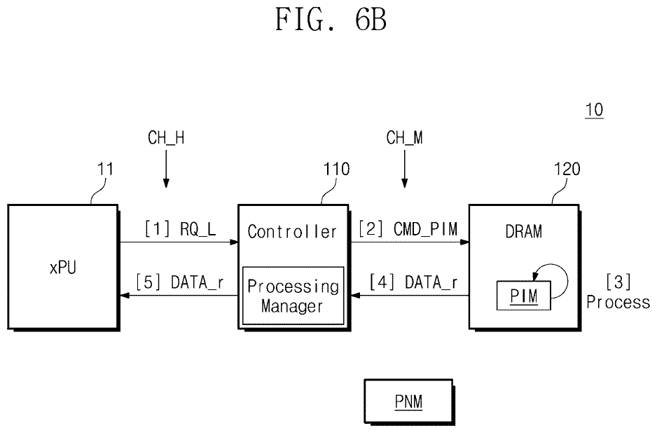

FIG. 6A and FIG. 6B are diagrams for describing the operation of the artificial intelligence computing system of FIG. 1. In some implementations, with reference to FIG. 6A and FIG. 6B, an operation (for example, the step S132 in FIG. 4) of processing a target layer with low computational intensity is described.

Referring to FIG. 6A and FIG. 6B, in a step S132-1, the processing device 11 may initiate processing on the target layer. In some implementations, the target layer may have a relatively low computational intensity (low Op/B).

In a step S132-2, the processing device 11 may transmit a third request RQ_L to the heterogeneous computing memory device 100. For example, as described above, the target layer with low computational intensity will be processed by the internal processing unit PIM included in the DRAM 120. In this case, the processing device 11 may transmit the third request RQ_L for processing the target layer through the internal processing unit PIM to the heterogeneous computing memory device 100. In some implementations, the third request RQ_L may include information on the target unit (i.e., the internal processing unit PIM). In some implementations, as in operation [1] of FIG. 6B, the third request RQ_L may be transmitted to the heterogeneous computing memory device 100 through the host channel CH_H.

In a step S132-3, the controller 110 of the heterogeneous computing memory device 100 may transmit the processing-in-memory command CMD_PIM to the DRAM 120 in response to the third request RQ_L. For example, the third request RQ_L may include information (e.g., information on the target unit) for processing the target layer by the internal processing unit PIM. The processing manager 111 of the controller 110 may generate the internal memory operation command CMD_PIM based on the information about the target unit of the third request RQ_L. In some implementations, as in operation [2] of FIG. 6B, the internal memory operation command CMD_PIM may be transmitted to the DRAM 120 through the memory channel CH_M.

In a step S132-4, the DRAM 120 of the heterogeneous computing memory device 100 may process the target layer based on the target data DATA_t in response to the processing-in-memory command CMD_PIM. For example, as in operation [3] of FIG. 6B, in response to the processing-in-memory command CMD_PIM, the DRAM 120 may read the target data DATA_t stored in the memory cells, and the internal processing unit PIM included in the DRAM 120 may perform an operation on the target data DATA_t, thereby processing the target layer.

In a step S132-5, the DRAM 120 of the heterogeneous computing memory device 100 may transmit the result data DATA_r to the controller 110. For example, the internal processing unit PIM included in the DRAM 120 may process the target layer to generate the result data DATA_r. In some implementations, as in operation [4] of FIG. 6B, the result data DATA_r may be transmitted to the controller 110 through the memory channel CH_M.

In a step S132-6, the controller 110 of the heterogeneous computing memory device 100 may transmit the result data DATA_r to the processing device 11. For example, as in operation [5] of FIG. 6B, the result data DATA_r may be transmitted to the processing device 11 through the host channel CH_H.

Although a configuration in which the result data DATA_r generated by the internal processing unit PIM is transmitted to the processing device 11 has been described in the implementation of FIG. 6A and FIG. 6B, the scope of the present disclosure is not limited thereto. For example, the result data DATA_r generated by the internal processing unit PIM may be stored in the DRAM 120. Alternatively, the result data DATA_r generated by the internal processing unit PIM may be stored or maintained in a data buffer (not shown) of the controller 110. Alternatively, the result data DATA_r generated by the internal processing unit PIM may be transmitted to or stored in at least one of the DRAM 120, the controller 110, and the processing device 11.

In some implementations, a location at which the result data DATA_r is stored or transmitted may be determined according to the computational intensity of a subsequent layer. For example, when the computational intensity of a subsequent layer using the computation result of the target layer is relatively low, the subsequent layer will be processed by the internal processing unit PIM. In this case, the result data DATA_r for the target layer may not be transmitted to the processing device 11 or the controller 110, but may be stored in the DRAM 120. Alternatively, when the computational intensity of a subsequent layer using the computation result of the target layer is medium, the subsequent layer will be processed by the near processing unit PNM. In this case, the result data DATA_r for the target layer may not be transmitted to the processing device 11, but may be stored in the DRAM 120 or transmitted to the controller 110. Alternatively, when the computational intensity of a subsequent layer using the computation result of the target layer is relatively high, the subsequent layer will be processed by the processing device 11. In this case, the result data DATA_r for the target layer may be transmitted to the processing device 11 and selectively stored in the DRAM 120.

As described with reference to FIG. 6A and FIG. 6B, when the computational intensity of the target layer is relatively low, the target layer may be processed by the internal processing unit PIM included in the DRAM 120. In this case, since the target data stored in the DRAM 120 does not pass through the memory channel CH_M and the host channel CH_H, there is no limitation on the data bandwidth. Accordingly, computational efficiency may be improved.

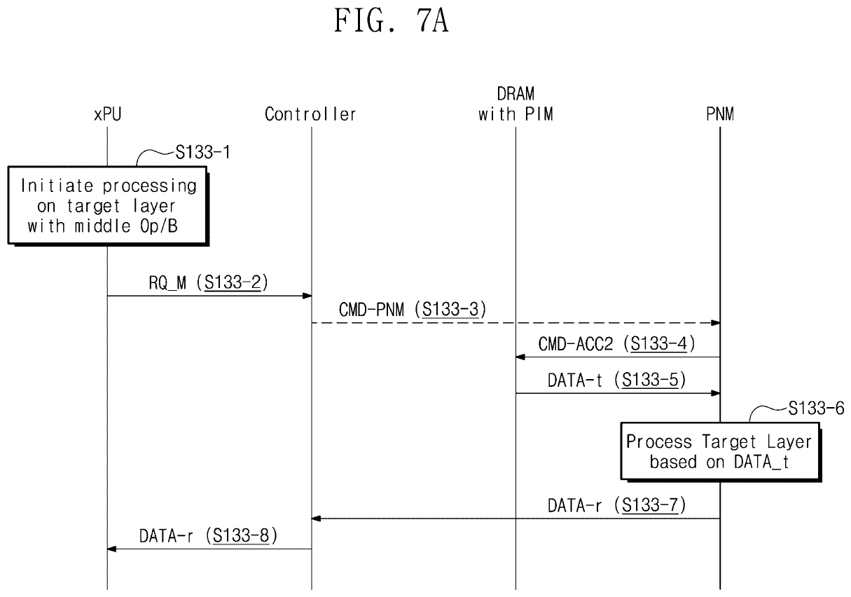

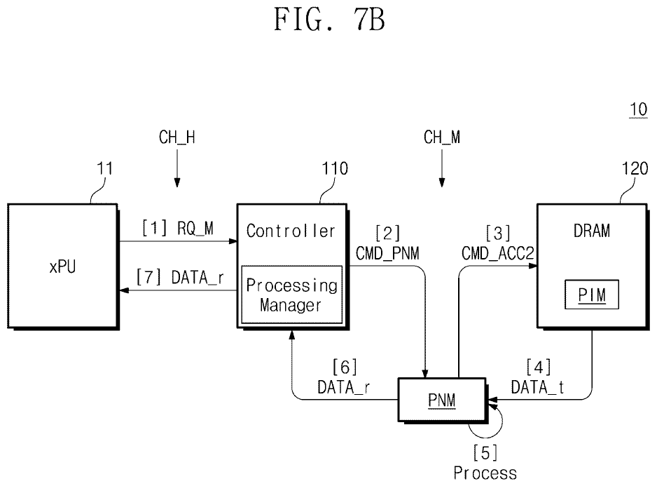

FIG. 7A and FIG. 7B are diagrams for describing the operation of the artificial intelligence computing system of FIG. 1. In some implementations, with reference to FIG. 7A and FIG. 7B, an operation (for example, the step S133 in FIG. 4) of processing a target layer having a medium computational intensity is described.

Referring to FIG. 7A and FIG. 7B, in a step S133-1, the processing device 11 may initiate processing on the target layer. In some implementations, the target layer may have a medium computational intensity (medium Op/B).

In a step S133-2, the processing device 11 may transmit the second request RQ_M to the heterogeneous computing memory device 100. For example, as described above, a target layer having a medium computational intensity will be processed by the near processing unit PNM. In this case, the processing device 11 may transmit the second request RQ_M for processing the target layer through the near processing unit PNM to the heterogeneous computing memory device 100. In some implementations, the second request RQ_M may include information on the target unit (i.e., the near processing unit PNM). In some implementations, as in operation [1] of FIG. 7B, the second request RQ_M may be transmitted to the heterogeneous computing memory device 100 through the host channel CH_H.

In a step S133-3, the controller 110 of the heterogeneous computing memory device 100 may transmit the processing-near-memory command CMD_PNM to the near processing unit PNM in response to the second request RQ_M. For example, the second request RQ_M may include information (e.g., information on the target unit) for processing the target layer by the near processing unit PNM. The processing manager 111 of the controller 110 may generate the processing-near-memory command CMD_PNM based on the information about the target unit of the second request RQ_M. In some implementations, as in operation [2] of FIG. 7B, the processing-in-memory command CMD_PNM may be transmitted to the near processing unit PNM through the memory channel CH_M.

In a step S133-4, the near processing unit PNM may transmit the second access command CMD_ACC2 to the DRAM 120 in response to the processing-near-memory command CMD_PNM. For example, the near processing unit PNM may need the target data DATA_t to process the target layer. Accordingly, the near processing unit PNM may transmit the second access command CMD_ACC2 for reading the target data DATA_t from the DRAM 120 to the DRAM 120. In some implementations, the processing-near-memory command CMD_PNM may include address information indicating a location where the target data DATA_t is stored. The near processing unit PNM may generate the second access command CMD_ACC2 for accessing the target data DATA_t based on the address information included in the processing-near-memory command CMD_PNM. In some implementations, the second access command CMD_ACC2 may be transmitted through the memory channel CH_M, as in operation [3] of FIG. 7B.

In a step S133-5, the DRAM 120 may transmit the target data DATA_t to the near processing unit PNM in response to the second access command CMD_ACC2. In some implementations, as in operation [4] of FIG. 7B, the target data DATA_t may be transmitted to the near processing unit PNM through the memory channel CH_M.

In a step S133-6, the near processing unit PNM may process the target layer based on the target data DATA_t. For example, as in operation [5] of FIG. 7B, the near processing unit PNM may process the target layer by repeatedly performing computations on the target data DATA_t.

In a step S133-7, the near processing unit PNM may transmit the result data DATA_r to the controller 110. For example, the near processing unit PNM processes the target layer, thereby generating the result data DATA_r. The near processing unit PNM may transmit the generated result data DATA_r to the controller 110. In some implementations, as in operation [6] of FIG. 7B, the result data DATA_r may be transmitted through the memory channel CH_M.

In a step S133-8, the controller 110 may transmit the result data DATA_r to the processing device 11. For example, as in operation [7] of FIG. 7B, the result data DATA_r may be transmitted to the processing device 11 through the host channel CH_H.

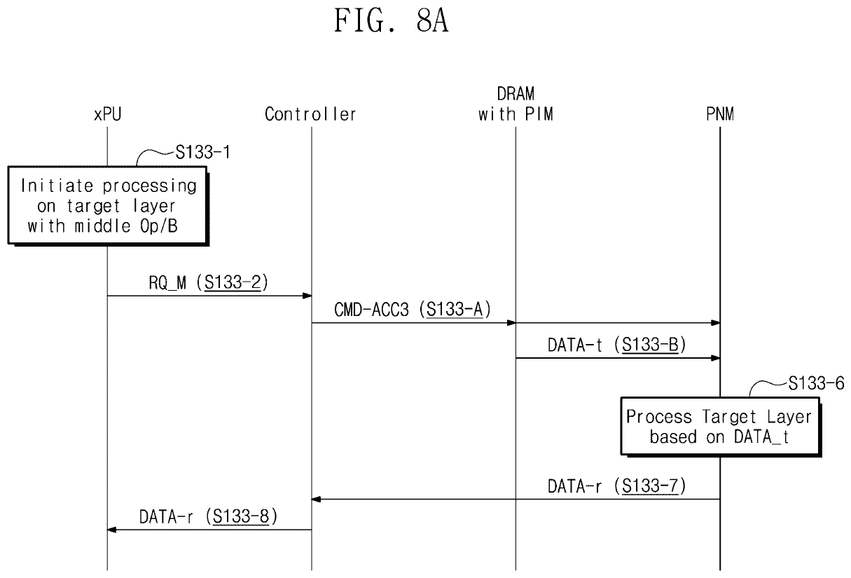

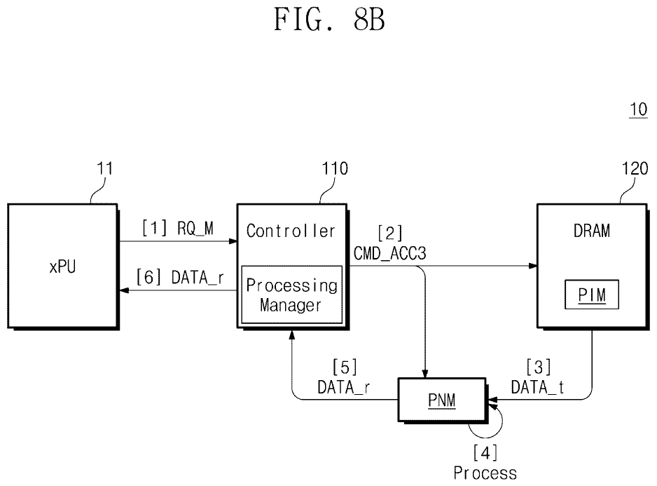

FIG. 8A and FIG. 8B are diagrams for describing the operation of the artificial intelligence computing system of FIG. 1. In some implementations, with reference to FIG. 8A and FIG. 8B, an operation (for example, the step S133 in FIG. 4) of processing a target layer having a medium computational intensity is described.

Referring to FIG. 8A and FIG. 8B, the processing device 11 may perform the operations of steps S133-1 and S133-2. Since the operations of step S133-1 and step S133-2 have been described with reference to FIG. 7A and FIG. 7B, a detailed description thereof is omitted.

In a step S133-A, the controller 110 of the heterogeneous computing memory device 100 may output the third access command CMD_ACC3 in response to the second request RQ_M. For example, the third request RQ_L may include information (e.g., information on the target unit) for processing the target layer by the near processing unit PNM. The third access command CMD_ACC3 may be a command for transferring the target data DATA_t stored in the DRAM 120 to the near processing unit PNM. As in operation [2] of FIG. 8B, the third access command CMD_ACC3 may be transmitted to the DRAM 120 and the near processing unit PNM through the memory channel CH_M.

In a step S133-B, the DRAM 120 may transmit the target data DATA_t to the near processing unit PNM in response to the third access command CMD_ACC3. For example, the DRAM 120 may read the target data DATA_t stored in the memory cells in response to the third access command CMD_ACC3. As in operation [3] of FIG. 8B, the DRAM 120 may transmit the read target data DATA_t to the near processing unit PNM through the memory channel CH_M.

Thereafter, the near processing unit PNM may perform the operations of the step S133-6 and the step S133-7, and the controller 110 may perform the operation of the step S133-8. The operations of the step S133-6, the step S133-7, and the step S133-8 have been described above, and thus a detailed description thereof is omitted.

In the implementation of FIG. 7A and FIG. 7B, the near processing unit PNM may directly control the DRAM 120 to access the target data DATA_t, while in the implementation of FIG. 8A and FIG. 8B, the controller 110 may control the DRAM 120 to transfer the target data DATA_t to the near processing unit PNM. However, it will be understood that the scope of the present disclosure is not limited thereto, and the data transfer manner between the respective components may be variously modified.

In the implementations of FIG. 7A, FIG. 7B, FIG. 8A, and FIG. 8B, the result data DATA_r generated by the near processing unit PNM is transmitted to the processing device 11. However, the scope of the present disclosure is not limited thereto. For example, the result data DATA_r generated by the near processing unit PNM may be stored in the DRAM 120. Alternatively, the result data DATA_r generated by the internal processing unit PNM may be stored or maintained in a data buffer (not shown) of the controller 110. Alternatively, the result data DATA_r generated by the internal processing unit PIM may be transmitted to or stored in at least one of the DRAM 120, the controller 110, and the processing device 11.

In some implementations, a location at which the result data DATA_r is stored or transmitted may be determined according to the computational intensity of a subsequent layer. For example, when the computational intensity of a subsequent layer using the computation result of the target layer is relatively low, the subsequent layer will be processed by the internal processing unit PIM. In this case, the result data DATA_r for the target layer may not be transmitted to the processing device 11 and the controller 110, but may be stored in the DRAM 120. Alternatively, when the computational intensity of a subsequent layer using the computation result of the target layer is medium, the subsequent layer will be processed by the near processing unit PNM. In this case, the result data DATA_r for the target layer may not be transmitted to the processing device 11, but may be stored in the DRAM 120 or transmitted to the controller 110. Alternatively, when the computational intensity of a subsequent layer using the computation result of the target layer is relatively high, the subsequent layer will be processed by the processing device 11. In this case, the result data DATA_r for the target layer may be transmitted to the processing device 11 and selectively stored in the DRAM 120.

In some implementations, when the result data DATA_r is stored in the DRAM 120, the result data DATA_r may be stored in the DRAM 120 by the controller 110. For example, the controller 110 may receive the result data DATA_r from the near processing unit PNM and store the result data DATA_r in the DRAM 120.

Alternatively, when the result data DATA_r is stored in the DRAM 120, the result data DATA_r may be stored in the DRAM 120 by the near processing unit PNM. For example, the near processing unit PNM may output a write command and the result data DATA_r through the memory channel CH_M. The DRAM 120 may receive the write command and the result data DATA_r via the memory channel CH_M, and store the result data in the memory cells in response to the received write command.

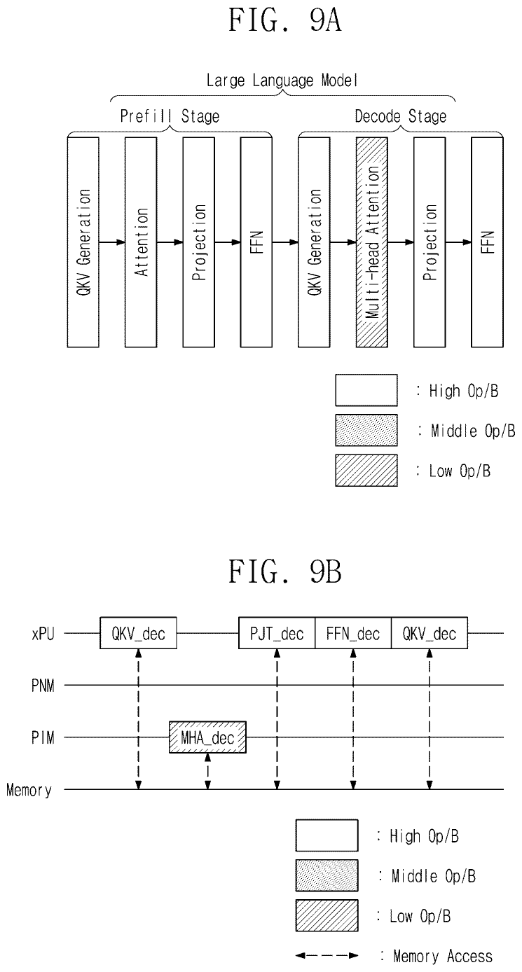

FIGS. 9A, 9B, 10A, 10B, 11A, 11B, 12A, and 12B are diagrams for describing inference of different example large language models using the artificial intelligence computing system of FIG. 1. In some implementations, referring to FIG. 1, FIG. 9A, and FIG. 9B, the artificial intelligence computing system 10 may be configured to perform inference or learning on a Large Language Model (LLM). A large language model is a type of artificial intelligence model that supports natural language processing. The inference of the large language model may include a prefill stage and a decode stage. The inference of the large language model refers to using a pre-trained model to generate outputs (predictions, classifications, text, etc.) without modifying the model's parameters.

The prefill stage may process a plurality of input tokens to compute an intermediate state (e.g., key and value), and use the computed intermediate state to generate a new token. In some implementations, a token may be an atomic part or an atomic unit of a language processed by the large language model. A natural language input to the large language model is converted into a plurality of input tokens. In the prefill stage, a new token may be formed based on the plurality of input tokens. In some implementations, in the prefill stage, the plurality of input tokens may be processed via a parallelized matrix operation. The decode stage may auto-regressively generate the output tokens one by one until the abort criterion is met. In the decode stage, each token may be processed through a vector operation.

That is, because the prefill stage performs parallelized matrix operation, it may have a relatively high computational intensity, and because the decode stage performs vector operation, it may have a relatively low computational intensity.

As a more detailed example, each of the prefill stage and the decode stage may include a Query, Key, and Value (QKV) generation layer, an attention layer, a projection layer, and a Feed-Forward Network (FFN) layer.

The QKV generation layer may perform embedding on the input words to generate query (Q; Query), key (K; Key), and value (V; Value) vectors. The attention layer may perform operations on queries, keys, and value vectors to determine the importance or weight between tokens. The projection layer may transform the dimension of the computational result. The FFN layer may convert the representation of each token separately.

In some implementations, the computational intensity of each layer described above may be relatively high, and in this case, each layer may be processed by the processing device 11 of the artificial intelligence computing system 10.

In some implementations, in the decode stage, the attention layer may use a multi-head attention (MHA) technique. The multi-head attention technique may refer to a technique of processing a plurality of requests in parallel. That is, the MHA-based attention layer MHA_dec of the decoding stage may have a relatively low computational intensity.

In this case, in the decoding stage, the processing unit (for example, the target unit) on which each layer is processed may be distributed to the processing device 11, the near processing unit PNM, and the internal processing unit PIM. For example, as shown in FIG. 9B, in the decode stage, a QKV generation layer QKV_dec, an MHA-based attention layer MHA_dec, a projection layer PJT_dec, and an FFN layer FFN_dec may be processed.

Since the QKV generation layer QKV_dec, the projection layer PJT_dec, and the FFN layer FFN_dec have relatively high computational intensity, they may be processed by the processing device 11. On the other hand, since the multi-head attention layer MHA_dec has a relatively low computational intensity, it may be processed by the internal processing unit PIM.

In some implementations, since the projection layer PJT_dec, which is a subsequent layer of the MHA-based attention layer MHA_dec, is processed by the processing device 11, the result data of the multi-head attention layer MHA_dec may be directly transmitted to the processing device 11.

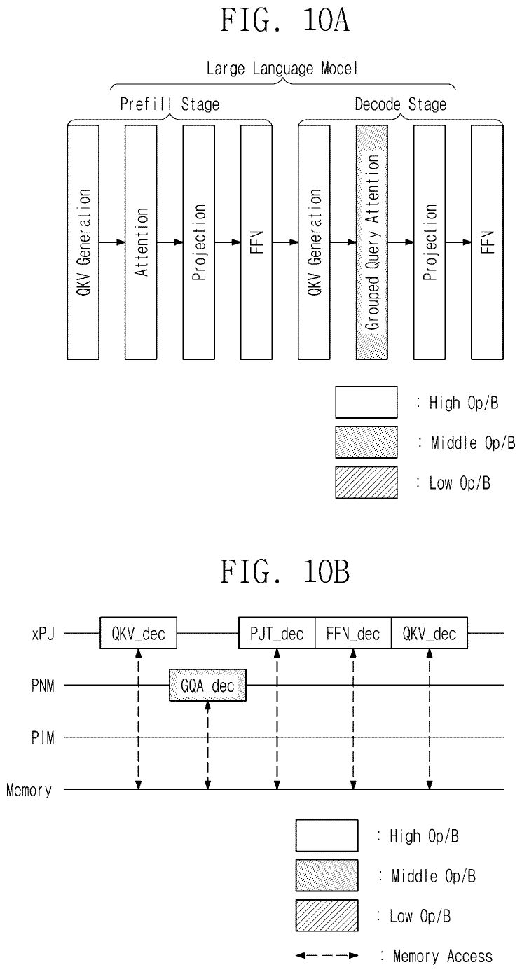

In some implementations, referring to FIG. 1, FIG. 10A, and FIG. 10B, the attention layer of the decode stage may be processed using a Grouped Query Attention (GQA) technique. The GQA technique may refer to a manner in which a query vector is divided into a plurality of groups, and each group uses a shared key-value. The computational intensity of the GQA-based attention layer may be higher than the computational intensity of the MHA-based attention layer and may be lower than the computational intensities of the other layers. In other words, the GQA-based attention layer may have a medium computational intensity. In this case, as shown in FIG. 10B, the GQA-based attention layer GQA_dec may be processed by the near processing unit PNM.

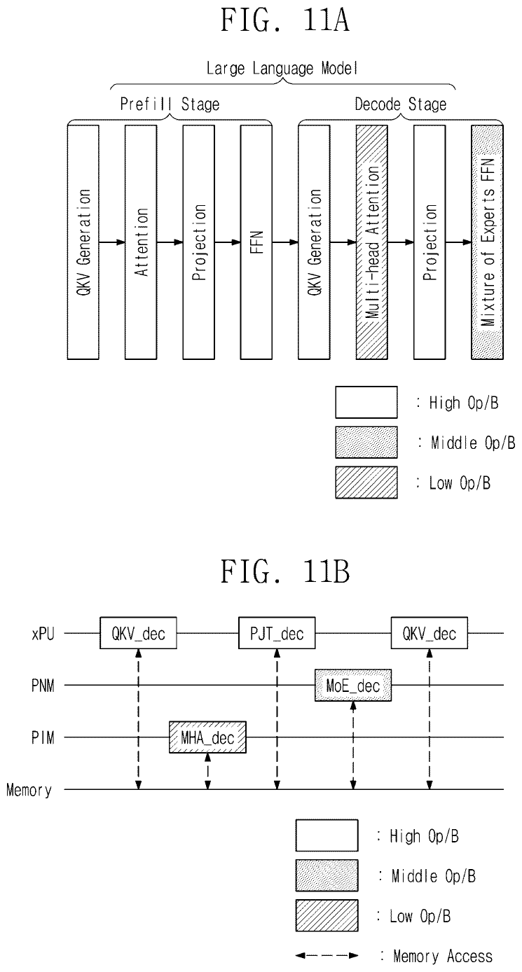

In some implementations,, referring to FIG. 1, FIG. 11A, and FIG. 11B, the attention layer of the decoding stage may use an MHA technique, and the FFN layer may use a MoE (Mixture of Experts) technique. The MoE technique may refer to a technique of dividing one layer or operation into a plurality of expert networks. Each network of the MoE technique may perform an operation independently, and the operation results are combined to generate a final output. In some implementations, the MoE-based FFN layer MoE_dec may have a medium computational intensity. Therefore, in the decoding stage, the MHA-based attention layer MHA_dec may be processed by the internal processing unit PIM, and the MoE-based FFN layer MoE_dec may also be processed by the near processing unit PNM.

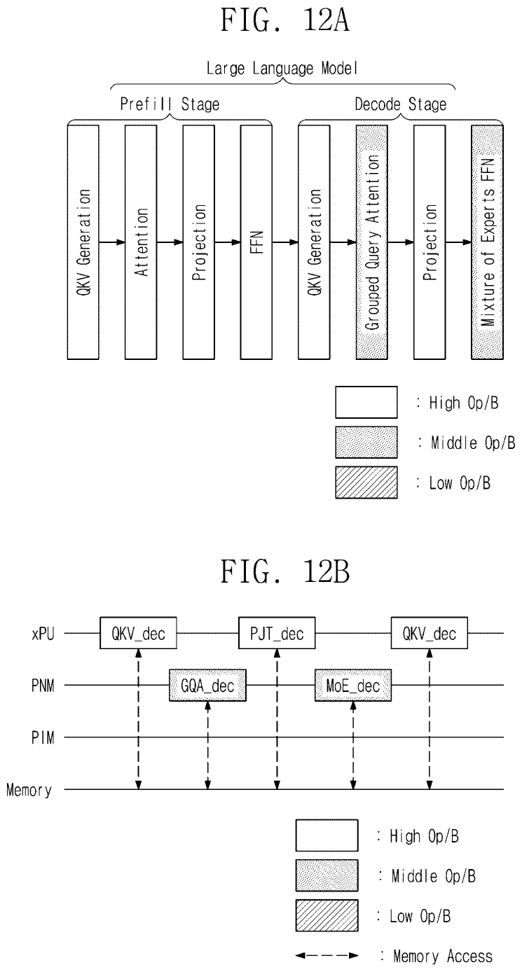

In some implementations,, referring to FIG. 1, FIG. 12A, and FIG. 12B, the attention layer of the decode stage may use a GQA technique, and the FFN layer may use a MoE technique. In this case, the GQA-based attention layer GQA_dec may have a medium computational intensity, and the MoE-based FFN layer MoE_dec may also have a medium computational strength. Therefore, in the decoding stage, the GQA-based attention layer GQA_dec and the MoE-based FFN layer MoE_dec may be processed by the near processing unit PNM.

As described above, inference or learning for a large language model may include a plurality of layers, and the plurality of layers may have different computational intensities, according to an implementation. Each of the plurality of layers may be processed by the processing device 11, the internal processing unit PIM, or the near processing unit PNM according to the computation intensity. In this case, since each layer is efficiently processed, the overall efficiency of inference or learning of the large language model is improved.

In some implementations, MHA-based attention layer or the GQA-based attention layer may perform operations on query, key, and value for each head. In this case, when the operation of each head is completed, the head for which the operation is completed is transmitted to the processing device 11, and the processing device 11 may process the projection layer for the received head. Therefore, while the MHA-based attention layer or the GQA-based attention layer is processed by the internal processing unit PIM or the near processing unit PNM, the processing device 11 may process the projection layer for the received heads. That is, the execution sections of the attention layer and the projection layer overlap with each other, whereby the overall processing time may be shortened.

Alternatively, the MoE-based FFN layer may take up most of the overall processing time. In this case, while the MoE-based FFN layer is processed by the near processing unit PNM, utilization of the processing device 11 and the internal processing unit PIM may be degraded. To compensate for this, one batch is divided into two sub-batches, and while the MoE-based FFN layer for one sub-batch is processed by the near processing unit PNM, the MoE-based FFN layer may be processed for another sub-batch by using the processing device 11 and the internal processing unit PIM. As a result, the overall utilization of the components can be improved.

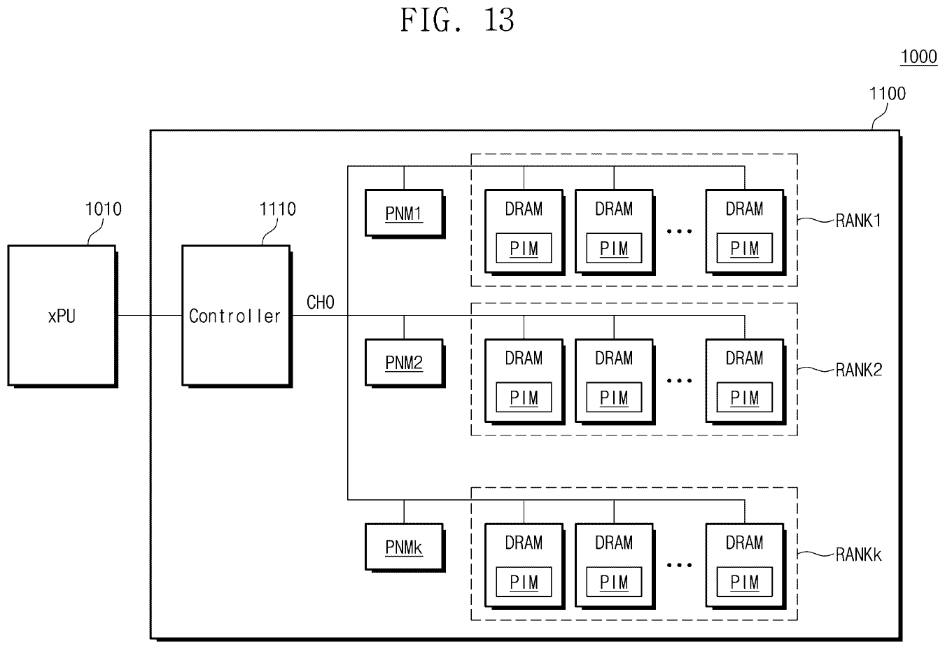

FIG. 13 is a block diagram illustrating an artificial intelligence computing system according to some implementations of the present disclosure. In the following, for convenience of description, detailed descriptions of the above-described components or operating methods thereof are omitted. However, the scope of the present disclosure is not limited thereto, and in the artificial intelligence computing system described with reference to the following drawings, the target unit on which the target layer is to be processed may be distributed according to the computational intensity of the target layer.

Referring to FIG. 13, an artificial intelligence computing system 1000 may include a processing device 1010 and a heterogeneous computing memory device 1100. The processing device 1010 may be computing hardware optimized for large-scale neural network processing such as various types of processing units (xPUs), for example, a tensor processing unit (TPU) or a neural processing unit (NPU), or computing hardware optimized for parallel computing processing such as a graphics processing unit (GPU).

The heterogeneous computing memory device 1100 may include a controller 1110, a plurality of DRAMs, and a plurality of near processing units PNM1 to PNMk. Each of the plurality of DRAMs may include an internal compute unit PIM. Since the operations of the controller 1110, the plurality of DRAMs, the plurality of near processing units PNM1 to PNMk, and the internal processing unit PIM have been described above, a detailed description thereof is omitted.

The plurality of DRAMs may communicate with the controller 1110 through a 0-th memory channel CH0. That is, the plurality of DRAMs may share the 0-th memory channel CH0. The plurality of DRAMs may be divided into a plurality of ranks RANK1 to RANKk.

The plurality of near processing units PNM1 to PNMk may correspond to the plurality of ranks RANK1 to RANKk, respectively. For example, the first near processing unit PNM1 may perform an operation on data stored in DRAMs included in the first rank RANK1. The second near processing unit PNM2 may perform an operation on data stored in DRAMs included in the second rank RANK2. The k-th near processing unit PNMk may perform an operation on data stored in DRAMs included in the k-th rank RANKk. That is, the near processing unit corresponding to each of the plurality of ranks RANK1 to RANKk may be allocated.

In some implementations, it is described that the plurality of near processing units PNM1 to PNMk perform an operation on data stored in DRAMs of corresponding rank, but the scope of the present disclosure is not limited thereto. The plurality of near processing units PNM1-PNMk may perform an operation on the data stored in the DRAMs of other ranks. For example, the first near processing unit PNM1 may correspond to DRAMs of the first rank RANK1. At this time, since the other ranks RANK2 to RANKk share the 0-th memory channel CH0, the first near processing unit PNM1 may transmit/receive data to/from the DRAMs of the other ranks RANK2 to RANKk. That is, the first near processing unit PNM1 may perform an operation on DRAMs of different ranks RANK2 to RANKk.

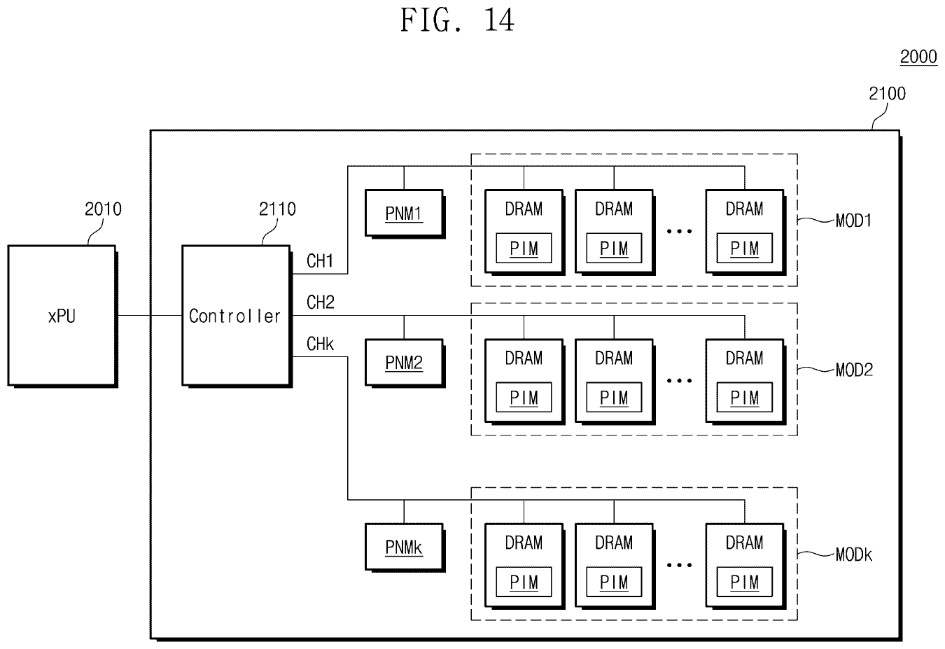

FIG. 14 is a block diagram illustrating an artificial intelligence computing system according to some implementations of the present disclosure. Referring to FIG. 14, an artificial intelligence computing system 2000 may include a processing device 2010 and a heterogeneous computing memory device 2100. The heterogeneous computing memory device 2100 may include a controller 2110, a plurality of modules MOD1 to MODk, and a plurality of near processing units PNM1 to PNMk. Each of the plurality of modules MOD1 to MODk may include a plurality of DRAMs, and each of the plurality of DRAMs may include an internal processing unit PIM.

The DRAMs in the plurality of modules MOD1 to MODk may be connected to the controller 2110 through different memory channels CH1 to CHk. For example, DRAMs of the first module MOD1 may be connected to the controller 2110 through the first memory channel CH1. The DRAMs of the second module MOD2 may be connected to the controller 2110 through the second memory channel CH2. The DRAMs of the k-th module MODk may be connected to the controller 2110 through the k-th memory channel CHk.

In some implementations, the plurality of near processing units PNM1 to PNMk may be allocated to a plurality of memory channels CH1 to CHk, respectively. For example, the first near processing unit PNM1 may be connected to the first memory channel CH1, and may perform an operation on data stored in the DRAMs of the first module MOD1. The second near processing unit PNM2 may be connected to the second memory channel CH2, and may perform an operation on data stored in the DRAMs of the second module MOD2. The k-th near processing unit PNMk may be connected to the k-th memory channel CHk, and may perform an operation on data stored in the DRAMs of the k-th module MOD1.

In some implementations, the plurality of near processing units PNM1 to PNMk may be included in the plurality of modules MOD1 to MODk, respectively. For example, the first near processing unit PNM1 may be included in the first module MOD1. The second near processing unit PNM2 may be included in the second module MOD1. The k-th neighboring operation unit PNMk may be included in the k-th module MODk.

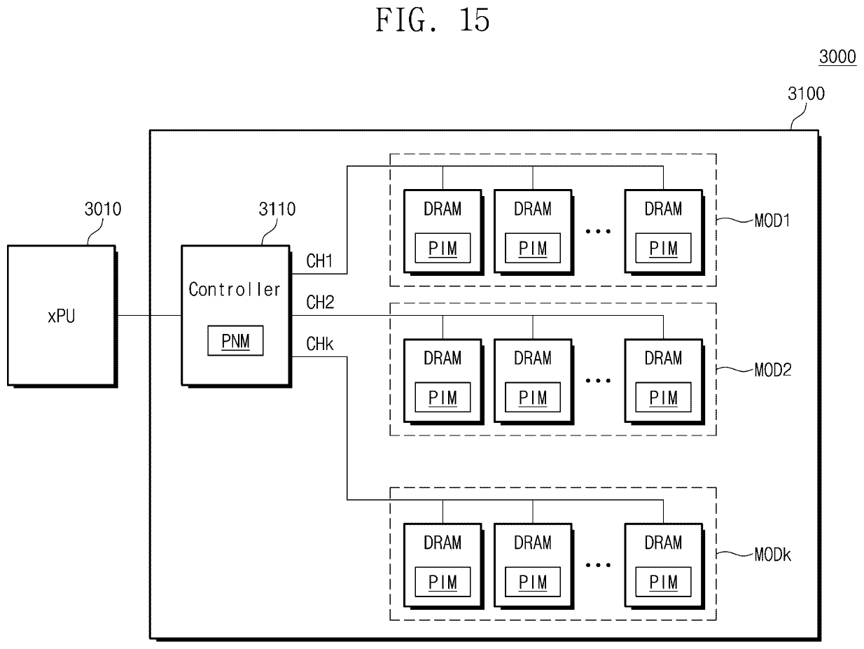

FIG. 15 is a block diagram illustrating an artificial intelligence computing system according to some implementations of the present disclosure. Referring to FIG. 15, an artificial intelligence computing system 3000 may include a processing device 3010 and a heterogeneous computing memory device 3100. The heterogeneous computing memory device 3100 may include a controller 3110 and a plurality of modules MOD1 to MODk. Each of the plurality of modules MOD1 to MODk may include a plurality of DRAMs, and each of the plurality of DRAMs may include an internal processing unit PIM. The plurality of modules MOD1 to MODk may be connected to the controller 3110 through different memory channels CH1 to CHk.

In some implementations, the controller 3110 may include a near processing unit PNM. As described above, the near processing unit PNM may perform computations on data stored in the plurality of DRAMs. In some implementations, except that the near processing unit PNM is provided in the controller 3110, other operation methods are similar to those described above, and thus a detailed description thereof is omitted.

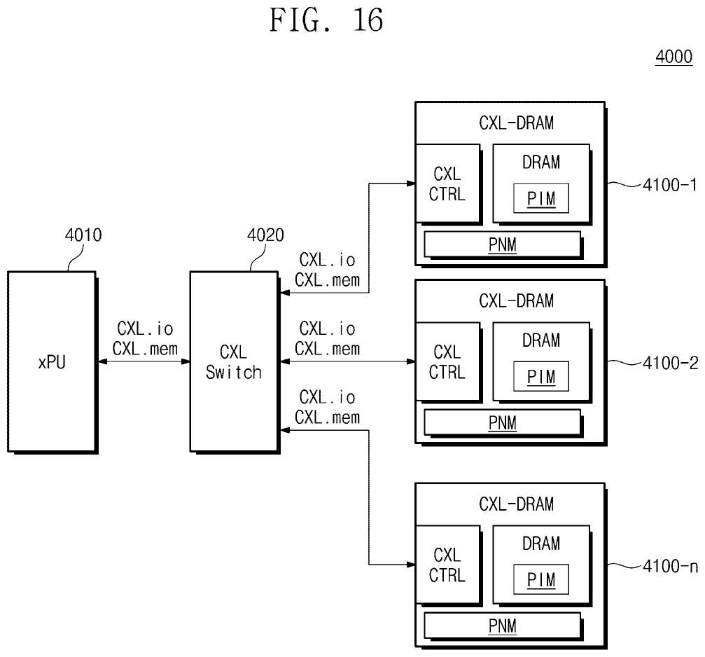

FIG. 16 is a block diagram illustrating an artificial intelligence computing system according to some implementations of the present disclosure. Referring to FIG. 16, an artificial intelligence computing system 4000 may include a processing device 4010, a CXL switch 4020, and a plurality of CXL-DRAMs 4100-1 to 4100-n. Each of the plurality of CXL-DRAMs 4100-1 to 4100-n may include a CXL controller, a DRAM, and a near processing unit PNM, and the DRAM may include an internal processing unit PIM. In some implementations, the CXL-DRAM may operate similarly to the heterogeneous computation memory device described with reference to FIGS. 1-15.

In some implementations, the processing device 4010 may communicate with the plurality of CXL-DRAMs 4100-1 to 4100-n via the CXL switch 4020. In some implementations, the processing device 4010, the CXL switch 4020, and the plurality of CXL-DRAMs 4100-1 to 4100-n may communicate based on a CXL interface. For example, the processing device 4010, the CXL switch 4020, and the plurality of CXL-DRAMs 4100-1 to 4100-n may communicate with each other based on a CXL.io protocol or a CXL.mem protocol. As an example, CXL.io may have a PCIe-based non-consistent input/output protocol, as defined by the CXL standard. CXL.mem may be a memory access protocol that supports accessing memory, as defined by the CXL standard. The CXL switch 4020 may arbitrate between the processing device 4010 and the plurality of CXL-DRAMs 4100-1 to 4100-n based on the CXL interface.

As described above, each of the plurality of CXL-DRAMs 4100-1 to 4100-n may include a near processing unit PNM and an internal processing unit PIM, and may support heterogeneous computations. That is, when the artificial intelligence computation system 4000 infers or learns an artificial intelligence model, each layer may be processed by the processing device 4010, processed by the near processing units PNM of the plurality of CXL-DRAMs 4100-1 to 4100-n, or processed by the internal processing unit PIM of the plurality of the CXL-RAMs 4100-1 and 4100-n according to the computational intensity of each layer.

In some implementations, the plurality of CXL-DRAMs 4100-1 to 4100-n may be implemented based on form factors such as E1.S, E1.L, E3.S, E3.L, PCIe AIC (CEM), etc. Alternatively, the plurality of CXL-DRAMs 4100-1 to 4100-n may be implemented based on a U.2 form factor, an M.2 form factor, or other various forms of PCIe-based form factor, or other various forms or small form factors. The plurality of CXL-DRAMs 4100-1 to 4100-n may be implemented in various forms of form factors, and may support a hot-plug function that may be mounted or removable on a physical port of the CXL switch 4020. Accordingly, the number configuration of the plurality of CXL-DRAMs 4100-1 to 4100-n may vary in various ways, and in this case, a configuration optimized for performance and power may be implemented according to the configuration of the artificial intelligence model executed by the artificial intelligence computing system 4000 (e.g., data length, input frequency, and the like).

In the implementation of FIG. 16, the near processing unit PNM is shown as separate hardware included in the CXL-DRAM, but the scope of the present disclosure is not limited thereto. For example, the near processing unit PNM may be included in the CXL controller, as described with reference to FIG. 15.

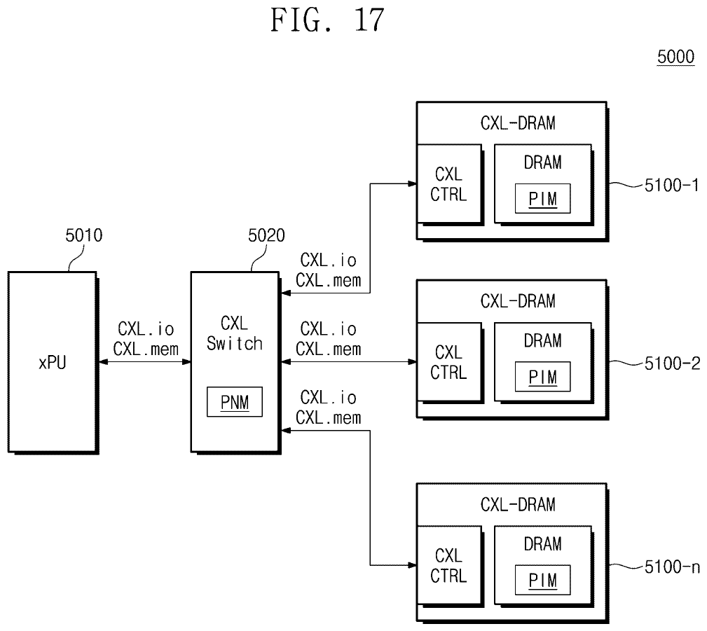

FIG. 17 is a block diagram illustrating an artificial intelligence computing system according to some implementations of the present disclosure. Referring to FIG. 17, an artificial intelligence computing system 5000 may include a processing device 5010, a CXL switch 5020, and a plurality of CXL-DRAMs 5100-1 to 5100-n. Each of the plurality of CXL-DRAMs 5100-1 to 5100-n may include a CXL controller and a DRAM, and the DRAM may include an internal processing unit PIM.

In some implementations, each of the plurality of CXL-DRAMs 5100-1 to 5100-n may store or output data under the control of the processing device 5010. Alternatively, each of the plurality of CXL-DRAMs 5100-1 to 5100-n may perform an arithmetic operation using the internal processing unit PIM under the control of the processing device 5010.

In some implementations, the CXL switch 5020 may include a near processing unit PNM. The near processing unit PNM may be configured to process a layer of medium computational intensity, similarly as described above. Except that the near processing unit PNM is included in the CXL switch 5020, the remaining configurations or operations are similar to those described above, and thus a detailed description thereof is omitted.

As described above, according to implementations of the present disclosure, the CXL-DRAM connected to the processing device may include a near computing unit PNM and an internal processing unit PIM, and may provide a heterogeneous computing function through the near computing unit PNM and the internal processing unit PIM. In this case, layers having various computational intensities can be processed by different computational units. In this case, the processing efficiency of each layer may be improved, and the overall performance for inference of the artificial intelligence model may be improved.

In the implementations of FIG. 16 and FIG. 17, although a configuration in which a single processing device 4010 is provided and a configuration in which a single processing device 5010 is provided have been described, the scope of the present disclosure is not limited thereto. For example, a plurality of processing devices may be connected with the CXL switches 4020 and 5020, depending on the implementation of the system or the characteristics of the artificial intelligence model.

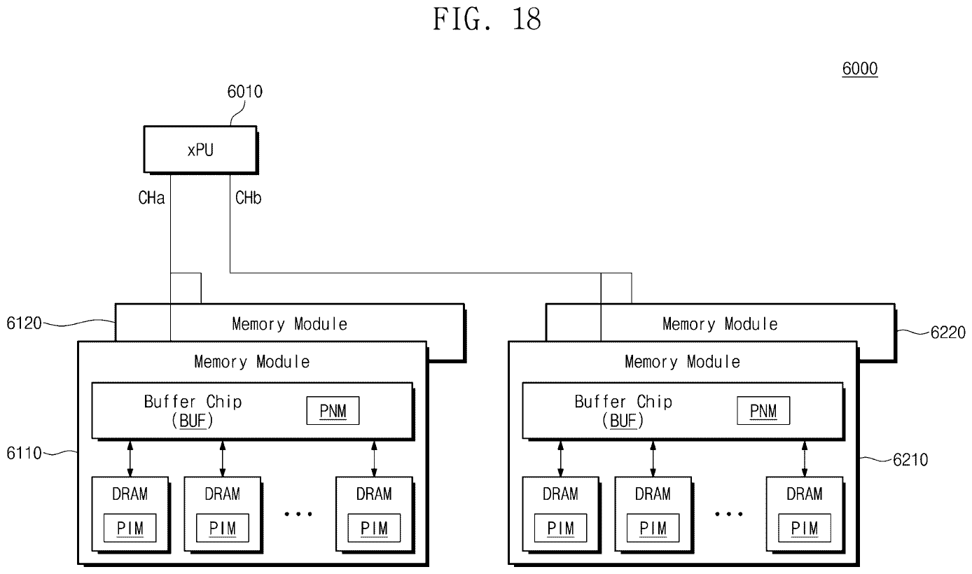

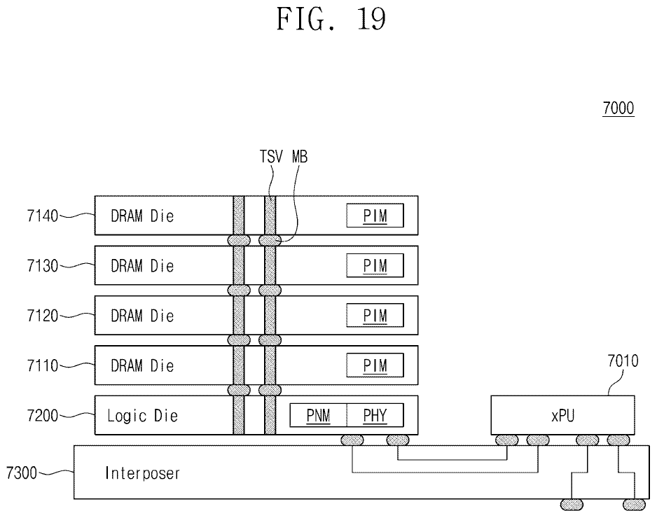

FIG. 18 is a block diagram illustrating an artificial intelligence computing system according to some implementations of the present disclosure. Referring to FIG. 18, an artificial intelligence computing system 6000 may include a processing device 6010 and a plurality of memory modules 6110, 6120, 6210, and 6220.

The processing device 6010 may communicate with the plurality of memory modules 6110, 6120, 6210, and 6220 through the a-th and b-th memory channels CHa and CHb. For example, the processing device 6010 may communicate with the memory modules 6110 and 6120 via an a-th memory channel CHa, and communicate with the memory modules 6210 and 6220 via a b-th memory channel CHb.

Each of the plurality of memory modules 6110, 6120, 6210, and 6220 may include a buffer chip BUF and a plurality of DRAMs. The buffer chip BUF may be configured to buffer signals (e.g., data signals, command/address signals, control signals, etc.) between the plurality of DRAMs and the processing device 6010. In some implementations, the buffer chip BUF may include a near processing unit PNM, and each of the plurality of DRAMs may include an internal processing unit PIM. In this case, similarly as described above, each of the plurality of memory modules 6110, 6120, 6210, and 6220 may support a heterogeneous computing function, and the target layer may be processed by the internal processing unit PIM, the near processing unit PNM, or the processing device 6010 according to the computational intensity.

In some implementations, the memory channels CHa and CHb may be a high-speed interface such as a DDR interface, and each of the plurality of memory modules 6110, 6120, 6210, and 6220 may have a structure of a dual in-line memory module (DIMM) in various forms such as a UDIMM, a RDIMM, a SODIMM, and the like.

FIG. 19 is a diagram illustrating an artificial intelligence computing system according to some implementations of the present disclosure. Referring to FIG. 19, the artificial intelligence computing system 7000 may include a processing device 7010, a plurality of DRAM dies 7110-7140, a logic die 7200, and an interposer 7300.

The plurality of DRAM dies 7110-7140 and the logic die 7200 may be vertically stacked on the interposer 7300, and may be electrically connected to each other through a through silicon via TSV and a micro bump MB. The logic die 7200 may be electrically connected to the processing device 7010 via an interposer 7300.

In some implementations, each of the plurality of DRAM dies 7110-7140 may include an internal processing unit PIM. The internal processing unit PIM may process a layer of relatively low computational intensity, as described above. In some implementations, the logic die 7200 may include a near processing unit PNM and a physical circuit PHY. The near processing unit PNM may process a layer of medium computational intensity as described above. Thus, depending on the computational intensity, the layers of the artificial intelligence model may be efficiently processed, thereby improving the overall performance of the artificial intelligence computational system.

In some implementations, the logic die 7200 may perform various operations to control the plurality of DRAM dies 7110-7140. In some implementations, the logic die 7200 may be a controller as described above or perform similar operations.

In some implementations, the plurality of DRAM dies 7110-7140 and the logic die 7200 may be packaged in various package manners and provided in one semiconductor package. The various package schemes may include at least one of Package on Package (PoP), Ball Grid Arrays (BGAs), Chip Scale Packages (CSPs), Plastic Leaded Chip Carrier (PLCC), Plastic Dual In Line Package (PDIP), Die in Waffle Pack, Die in Wafer Form, Chip On Board (COB), Ceramic Dual In Line package (CERDIP), Plastic Metric Quad Flat Pack (MQFP), Thin Quad Flatpack (TQFP), Small Outline Integrated Circuit (SOIC), Shrink Small Outline Package (SSOP), Thin Small Outline (TSOP), Thin QuAD Flatpack (TQFP), System In Package (SIP), Multi Chip Package (MCP), Wafer-level Fabricated Package (WFP), Wafer-Level Processed Stack Package (WSP).

Although the plurality of DRAM dies 7110-7140 and the logic die 7200 are stacked on the interposer 7300 and the processing device 7010 is shown as being provided in a separate region of the interposer 7300 in FIG. 19, the scope of the present disclosure is not limited thereto. For example, the processing device 7010, the plurality of DRAM dies 7110-7140, and the logic die 7200 may be vertically stacked on the same plane, and may be electrically connected to each other through a through electrode. In this case, the processing device 7010, the plurality of DRAM dies 7110 to 7140, and the logic die 7200 may be packaged in at least one of the various package manners described above and provided as one semiconductor package.

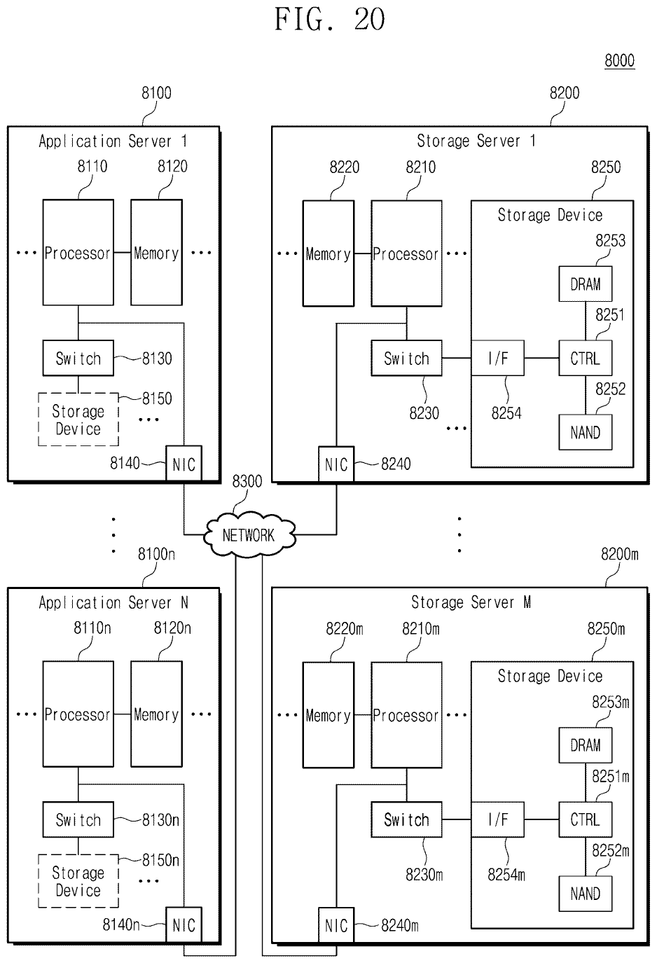

FIG. 20 is a diagram illustrating a data center to which a heterogeneous computing memory device according to some implementations of the present disclosure is applied.

Referring to FIG. 20, the data center 8000 may be a facility that collects various types of data and provides services, and may be referred to as a data storage center. The data center 8000 may be a system for operating a search engine and a database, and may be a computing system used by companies, such as banks or government agencies. The data center 8000 may include application servers 8100 to 8100n and storage servers 8200 to 8200m. The number of application servers 8100 to 8100n and the number of storage servers 8200 to 8200m may be variously selected according to implementations. The number of application servers 8100 to 8100n may be different from the number of storage servers 8200 to 8200m.

The application server 8100 or the storage server 8200 may include at least one of processors 8110 and 8210 and memories 8120 and 8220. The storage server 8200 will now be described as an example. The processor 8210 may control all operations of the storage server 8200, access the memory 8220, and execute instructions and/or data loaded in the memory 8220. The memory 8220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVDIMM). In some implementations, the number of processors 8210 and the number of memories 8220 included in the storage server 8200 may be variously selected. In some implementations, the processor 8210 and the memory 8220 may provide a processor-memory pair. In some implementations, the number of processors 8210 may be different from the number of memories 8220. The processor 8210 may include a single-core processor or a multi-core processor. The above description of the storage server 8200 may be similarly applied to the application server 8100. In some implementations, the application server 8100 may not include a storage device 8150. The storage server 8200 may include at least one storage device 8250. The number of storage devices 8250 included in the storage server 8200 may be variously selected according to implementations.

The application servers 8100 to 8100n may communicate with the storage servers 8200 to 8200m through a network 8300. The network 8300 may be implemented by using a fiber channel (FC) or Ethernet. In this case, the FC may be a medium used for relatively high-speed data transmission and use an optical switch with high performance and high availability. The storage servers 8200 to 8200m may be provided as file storage devices, block storage devices, or object storage devices, according to an access method of the network 8300.

In some implementations, the network 8300 may be a storage-dedicated network, such as a storage area network (SAN). For example, the SAN may be an FC-SAN, which uses an FC network and is implemented according to an FC protocol (FCP). As another example, the SAN may be an Internet protocol SAN (IP-SAN), which uses a transmission control protocol internet protocol (TCP/IP) network and is implemented according to a SCSI over TCP/IP or Internet SCSI (iSCSI) protocol. In another implementation, the network 8300 may be a general network, such as a TCP/IP network. For example, the network 8300 may be implemented according to a protocol, such as FC over Ethernet (FCoE), network attached storage (NAS), and NVMe over Fabrics (NVMe-oF).

Hereinafter, the application server 8100 and the storage server 8200 will mainly be described. A description of the application server 8100 may be applied to another application server 8100n, and a description of the storage server 8200 may be applied to another storage server 8200m.

The application server 8100 may store data, which is requested by a user or a client to be stored, in one of the storage servers 8200 to 8200m through the network 8300. Also, the application server 8100 may obtain data, which is requested by the user or the client to be read, from one of the storage servers 8200 to 8200m through the network 8300. For example, the application server 8100 may be implemented as a web server or a database management system (DBMS).

The application server 8100 may access a memory 8120n or a storage device 8150n, which is included in another application server 8100n, through the network 8300. Alternatively, the application server 8100 may access memories 8220 to 8220m or storage devices 8250 to 8250m, which are included in the storage servers 8200 to 8200m, through the network 8300. Thus, the application server 8100 may perform various operations on data stored in application servers 8100 to 8100n and/or the storage servers 8200 to 8200m. For example, the application server 8100 may execute an instruction for moving or copying data between the application servers 8100 to 8100n and/or the storage servers 8200 to 8200m. In this case, the data may be moved from the storage devices 8250 to 8250m of the storage servers 8200 to 8200m to the memories 8120 to 8120n of the application servers 8100 to 8100n directly or through the memories 8220 to 8220m of the storage servers 8200 to 8200m. The data moved through the network 8300 may be data encrypted for security or privacy.

The storage server 8200 will now be described as an example. An interface 8254 may provide a physical connection between a processor 8210 and a controller 8251 and a physical connection between a network interface card (NIC) 8240 and the controller 8251. For example, the interface 8254 may be implemented using a direct attached storage (DAS) scheme in which the storage device 8250 is directly connected with a dedicated cable. For example, the interface 8254 may be implemented by using various interface schemes, such as ATA, SATA, e-SATA, SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 8200 may further include a switch 8230 and the NIC (Network InterConnect) 8240. The switch 8230 may selectively connect the processor 8210 to the storage device 8250 or selectively connect the NIC 8240 to the storage device 8250 via the control of the processor 8210.

In some implementations, the NIC 8240 may include a network interface card and a network adaptor. The NIC 8240 may be connected to the network 8300 by a wired interface, a wireless interface, a Bluetooth interface, or an optical interface. The NIC 8240 may include an internal memory, a digital signal processor (DSP), and a host bus interface and be connected to the processor 8210 and/or the switch 8230 through the host bus interface. The host bus interface may be implemented as one of the above-described examples of the interface 8254. In some implementations, the NIC 8240 may be integrated with at least one of the processor 8210, the switch 8230, and the storage device 8250.

In the storage servers 8200 to 8200m or the application servers 8100 to 8100n, a processor may transmit a command to storage devices 8150 to 8150n and 8250 to 8250m or the memories 8120 to 8120n and 8220 to 8220m and program or read data. In this case, the data may be corrected by an ECC engine. The data may be subject to a data bus inversion (DBI) operation or a data masking (DM) operation, and may include cyclic redundancy code (CRC) information. The data may be encrypted for security or privacy purposes.

Storage devices 8150 to 8150n and 8250 to 8250m may transmit a control signal and a command/address signal to NAND flash memory devices 8252 to 8252m in response to a read command received from the processor. Thus, when data is read from the NAND flash memory devices 8252 to 8252m, a read enable RE signal may be input as a data output control signal, and thus, the data may be output to a DQ bus. A data strobe signal DQS may be generated using the RE signal. The command and the address signal may be latched in a page buffer, depending on a rising edge or falling edge of a write enable WE signal.

The controller 8251 may control all operations of the storage device 8250. In some implementations, the controller 8251 may include SRAM. The controller 8251 may write data to the NAND flash memory device 8252 in response to a write command or read data from the NAND flash memory device 8252 in response to a read command. For example, the write command and/or the read command may be provided from the processor 8210 of the storage server 8200, the processor 8210m of another storage server 8200m, or the processors 8110 and 8110n of the application servers 8100 and 8100n. DRAM 8253 may temporarily store (or buffer) data to be written to the NAND flash memory device 8252 or data read from the NAND flash memory device 8252. Also, the DRAM 8253 may store metadata. Here, the metadata may be user data or data generated by the controller 8251 to manage the NAND flash memory device 8252. The storage device 8250 may include a secure element SE for security or privacy.

In some implementations, the heterogeneous computing memory device described with reference to FIGS. 1-19 may be applied to the data center 8000 of FIG. 20. For example, storage servers 8200-8200m or application servers 8100-8100n may infer or learn an artificial intelligence model, where memory 8120-8120n, 8220-8220m may be or operate similarly to the heterogeneous computation memory device described with reference to FIGS. 1-19. That is, each of the memories 8120 to 8120n and 8220 to 8220m may include a near processing unit PNM and an internal processing unit PIM, and may process various layers according to operation strength. Thus, performance and efficiency for inference and learning of artificial intelligence models can be improved.

According to the present disclosure, the heterogeneous computing memory device may include a memory near processing unit PNM and a memory internal processing unit PIM. In this case, a plurality of layers for inferring the artificial intelligence model may be processed by different operation units, according to respective operation intensities. Accordingly, performance and efficiency for inference or learning of artificial intelligence models can be improved. Accordingly, a heterogeneous computation memory device having improved performance and efficiency, and an artificial intelligence computation system including the same, are provided.

As used herein, the term “at least one of” can refer to and encompass any and all possible combinations of one or more of the associated listed terms. For example, the term “at least one of A, B, or C” means that (i) at least one of A, (ii) at least one of B, (iii) at least one of C, (iv) at least one of A and at least one of B, (v) at least one of B and at least one of C, (vi) at least one of A and at least one of C, or (vi) at least one of A, at least one of B and at least one of C are possible, where A, B and C may be singular or plural.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The foregoing are specific implementations for carrying out the present disclosure. The present disclosure will include not only the implementations described above, but also implementations that can be simply changed in design or easily changed. The invention will also include techniques that can be readily modified and practiced using implementations. Therefore, the scope of the present disclosure should not be limited to the above-described implementations, but should be defined by the following claims as well as those equivalent to the claims of the present disclosure.

What is claimed:

1. A heterogeneous computing memory device comprising:
a memory including a processing-in-memory (PIM) unit;
a processing-near-memory (PNM) unit; and
a controller configured to receive first to third requests from an external processing device via a host channel and configured to, in response to the first to third requests, control the memory and the PNM unit via a memory channel,
wherein the first request corresponds to a first layer having a first computational intensity, the second request corresponds to a second layer having a second computational intensity lower than the first computational intensity, and the third request corresponds to a third layer having a third computational intensity lower than the second computational intensity, and
wherein the controller is configured to:
in response to the first request, provide first target data stored in the memory to the external processing device;
in response to the second request, control the PNM unit to process the second layer by the PNM unit; and
in response to the third request, control the memory to process the third layer by the PIM unit of the memory.

2. The heterogeneous computing memory device of claim 1, wherein the first layer is configured to be processed by the external processing device.

3. The heterogeneous computing memory device of claim 1, wherein the PNM unit is configured to perform a computation on second target data stored in the memory to process the second layer under control of the controller.

4. The heterogeneous computing memory device of claim 3, wherein the controller is configured to, in response to the second request, transmit a processing-near-memory command to the PNM unit via the memory channel,
wherein the PNM unit is configured to, in response to the processing-near-memory command, transmit a first access command to the memory, and
wherein the memory is configured to, in response to the first access command, transmit the second target data to the PNM unit via the memory channel.

5. The heterogeneous computing memory device of claim 3, wherein the controller is configured to, in response to the second request, transmit a second access command to the memory, and
wherein the memory is configured to, in response to the second access command, transmit the second target data to the PNM unit via the memory channel.

6. The heterogeneous computing memory device of claim 1, wherein the memory is configured to store output data of the PIM unit.

7. The heterogeneous computing memory device of claim 1, wherein the PNM unit is configured to store output data of the PNM unit in the memory.

8. The heterogeneous computing memory device of claim 1, wherein the PNM unit is configured to transmit output data of the PNM unit to the controller; and
wherein the controller is configured to store the output data in the memory via the memory channel or transmit the output data to the external processing device via the host channel.

9. The heterogeneous computing memory device of claim 1, wherein the second layer includes a Mixture of Expert (MoE)-based Feed-Forward Network (FFN) layer or a Grouped-Query Attention (GQA)-based attention layer of a Large Language Model (LLM), and
wherein the third layer includes a Multi-Head Attention (MHA)-based attention layer of the LLM.

10. The heterogeneous computing memory device of claim 1, wherein the host channel is based on a compute eXpress Link (CXL) interface.

11. An artificial intelligence computing system configured to perform inference using an artificial intelligence model, the system comprising:
a first heterogeneous computing memory device; and
a first processing device coupled to the first heterogeneous computing memory device via a first host channel, and configured to perform inference using the artificial intelligence model,
wherein the first heterogeneous computing memory device comprises:
a first processing-near-memory (PNM) unit;
a first memory including a first processing-in-memory (PIM) unit and configured to store data; and
a first controller electrically connected to the first memory and the first PNM unit via a first memory channel, and configured to control the first memory and first PNM unit in response to a first request from the first processing device,
wherein the artificial intelligence model comprises a plurality of layers, and
wherein each of the plurality of layers is configured to be respectively processed by the first processing device, the first PNM unit, or the first PIM unit included in the first memory according to a respective computing intensity of each of the plurality of layers.

12. The artificial intelligence computing system of claim 11, wherein the first PIM unit is configured to process a first layer, and the first processing device is configured to process a second layer based on output data of the first PIM unit.

13. The artificial intelligence computing system of claim 11, wherein the first heterogeneous computing memory device comprises:
a second memory electrically connected to the first memory channel,
wherein the second memory includes a second PIM unit.

14. The artificial intelligence computing system of claim 11, wherein the first heterogeneous computing memory device comprises:
a second memory including a second PIM unit; and
a second PNM unit,
wherein the first controller is electrically connected to the second memory and the second PNM unit via a second memory channel.

15. The artificial intelligence computing system of claim 11, comprises a second heterogeneous computing memory device connected through a second host channel,
wherein the second heterogeneous computing memory device comprises:
a second PNM unit;
a second memory including a second PIM unit and configured to store data; and
a second controller electrically connected to the second memory and the second PNM unit via a second memory channel, and configured to control the second memory and the second PNM unit in response to a second request from the first processing device.

16. The artificial intelligence computing system of claim 15, comprises:
a compute eXpress Link (CXL) switch configured to arbitrate a communication between the first processing device, the first heterogeneous computing memory device, and the second heterogeneous computing memory device.

17. The artificial intelligence computing system of claim 16, comprises a second processing device coupled with the CXL switch.

18. The artificial intelligence computing system of claim 11, wherein the first PNM unit is included in the first controller.

19. The artificial intelligence computing system of claim 18, comprises an interposer,
wherein the first controller and the first memory are vertically stacked on the interposer and included in one semiconductor package,
wherein the first controller and the first processing device communicate with each other via the interposer.

20. An artificial intelligence computing system comprising:
a processing device configured to process a first layer having a first computational intensity; and
a heterogeneous computing memory device configured to process a second layer having a second computational intensity lower than the first computational intensity and a third layer having a third computational intensity less than the second computational intensity,
wherein the heterogeneous computing memory device comprises:
a processing-near-memory (PNM) unit configured to process the second layer; and
a memory configured to store data, the memory including a processing-in-memory (PIM) unit configured to process the third layer.
